(19) United States
(12) Patent Application Publication
(10) Pub. No.: US 2020/0078757 A1
(43) Pub. Date: Mar. 12, 2020

(54) Methods and Systems for Forming Microcapsules

(71) Applicant: The Procter & Gamble Company, Cincinnati, OH (US)

(72) Inventors: Yousef Georges Aouad, Cincinnati, OH (US); Raul Rodrigo Gomez, Brussels (BE); John David Sadler, Cincinnati, OH (US)

(21) Appl. No.: 16/548,861

(22) Filed: Aug. 23, 2019

Related U.S. Application Data
(60) Provisional application No. 62/728,137, filed on Sep. 7, 2018.

(51) Int. Cl. B01J 13/04; B01J 13/20; B01J 13/22

(52) U.S. Cl. CPC B01J 13/043; B01J 13/22; B01J 13/206

(57) ABSTRACT

A method for producing microcapsules is provided. The method includes providing a core liquid comprising one or more oils and one or more surfactants and a shell liquid comprising water, one or more surfactants and at least one wall forming material. The method further includes forming a plurality of liquid droplets within a gas, wherein each of the plurality of liquid droplets has a core formed from the core liquid and a shell surrounding the core formed from the shell liquid, wherein the core liquid and shell liquid have a dynamic spreading coefficient greater than zero at 0.03 seconds. At least some of the water is evaporated within a drying chamber to form microcapsules.

### TECHNICAL FIELD

The present disclosure is generally related to methods and systems for forming microcapsules having a liquid core and a solid shell, and, more particularly, to methods for forming such microcapsules using a drying chamber.

### BACKGROUND

Microencapsulation refers to a process in which a first material or composition is enveloped by one or more second materials or compositions. The material inside the microcapsule is often referred to as the core, whereas the outer surface/layer of the microcapsule is sometimes also referred to as the shell. Microencapsulation of materials can provide a number of benefits, including protecting reactive substances in the core from the environment, separation of incompatible components, and/or controlling the release of the core material. Microencapsulation processes have been widely adopted in a variety of industries, including the agricultural, consumer goods, food, chemical and pharmaceutical industries.

A variety of microencapsulation processes exist, including solvent evaporation and extraction, cryogenic solvent extraction, interfacial polymerization, polyectrolyte complexation, and coacervation (which may occur by non-solvent addition, temperature change, incompatible polymer or salt addition, or polymer to polymer interaction), spray drying, spray chilling, spray desolvation, and supercritical fluid precipitation. See, e.g., Yeo, et. al, “Microencapsulation Methods for Delivery of Protein Drugs”, Biotechnol. Bioprocess Eng. (2001), 6:213-230 and Umner et al., “Microencapsulation: Process, Techniques, and Applications”, International Journal of Research in Pharmaceutical and Biomedical Sciences, (2011).

Spray drying is one of the more popular microencapsulation processes, particularly in the food industry. Poshadri et al., “Microencapsulation Technology: A Review”, J. Res. ANGRAU (2010). Some examples of spray drying processes and systems are described in U.S. Pat. Nos. 2,824,807; 4,187,617; 4,352,718; 4,963,226; 5,547,540; 5,487,916; and U.S. Publ. Nos.: 2012/0167410; 2014/0079747; and 2014/0086965.

There have been some attempts to use spray drying techniques to form microcapsules comprising a liquid core surrounded by a solid shell. For example, U.S. Publ. No. 2014/0342972 describes a process in which a polymeric shell solution comprising a mixture of water and ethanol is dried in heated air between 80° C. and 120° C. (in the examples). However, ethanol is a flammable material that can contribute to high volatile organic compounds (VOCs) in a drying process. Evaporation of ethanol at high temperatures in a spray dryer may also create explosion risks if the drying facility is not properly constructed. These facilities can be expensive to construct for commercial scale-up.

There are other challenges with forming microcapsules in a spray dryer. As the desired microcapsule size decreases, it can become increasingly difficult to control the kinetics, thermodynamics and hydrodynamics of liquid droplet formation in transient conditions in the time frame of 1 to 2 seconds (or less) during which the liquid droplets form. This is particularly true it is desired to further tightly control the size distribution and/or morphology of the dried microcapsules.

It is presently believed that some of the factors include: i) the fast time frame over which the liquid droplets form, ii) the small amount of water present, which may quickly evaporate from the shell liquid when forming small liquid droplets and microcapsules, iii) the presence of heat which can accelerate evaporation of the water from the shell liquid, iv) the changing make-up of the shell liquid as water evaporates, and v) turbulence of the gas in which the liquid droplet forms.

As such, it would be advantageous to provide improved systems and methods for producing microcapsules comprising a liquid core and a solid shell. Further, it would be advantageous to provide improved systems and methods for producing the foregoing in a drying chamber.

### SUMMARY

The present disclosure may fulfill one or more of the needs described above by, in one embodiment, a method for producing microcapsules comprising providing a core liquid comprising one or more oils and one or more surfactants and a shell liquid comprising water, one or more surfactants and at least one wall forming material. The method further comprises forming a plurality of liquid droplets within a gas, wherein each of the plurality of liquid droplets comprise a core formed from the core liquid and a shell surrounding the core formed from the shell liquid, wherein the core liquid and shell liquid have a dynamic spreading coefficient greater than zero at 0.03 seconds. At least some of the water is evaporated within a drying chamber to form a microcapsules.

### BRIEF DESCRIPTION OF THE DRAWINGS

FIG. 1 is a cross-sectional side view of one example of a microcapsule comprising a core bounded by a shell.

FIG. 2 is a schematic illustration of a non-limiting embodiment of a system for producing liquid droplets and microcapsules.

FIG. 3 is a cross-sectional schematic drawing of a non-limiting embodiment of a microfluidic device for producing a bi-component liquid stream that breaks-up into liquid droplets.

FIG. 4 is an enlarged, partial cross-sectional view of the drying chamber shown in FIG. 2.

FIG. 5 is a graph of the surface tensions versus bubble lifetime for various materials.

FIG. 6 is a graph of the surface tensions versus bubble lifetime for various materials.

FIG. 7 is a graph of the surface tensions versus bubble lifetime for various materials.

FIG. 8 is a graph of the surface tensions versus bubble lifetime for various materials.

FIG. 9 is a graph of the surface tensions versus bubble lifetime for various materials.

FIG. 10 is a graph of the surface tensions versus bubble lifetime for various materials.

FIG. 11 is a graph of the surface tensions versus bubble lifetime for various materials.

FIG. 12 is a graph of the surface tensions versus bubble lifetime for various materials.

FIG. 13 is a graph of the surface tensions versus bubble lifetime for various materials.

FIG. 14 is a graph of the surface tensions versus bubble lifetime for various materials.

FIG. 15 is a graph of the surface tensions versus bubble lifetime for various materials.

FIG. 16 is a graph of the surface tensions versus bubble lifetime for various materials.

FIG. 17 is a graph of surface tension versus bubble lifetime for various materials.

FIG. 18 is a graph of the surface tensions versus bubble lifetime for various materials.

FIG. 19 is a graph of surface tension versus bubble lifetime for various materials.

FIG. 20 is a graph of interfacial surface tension (IFT) versus bubble lifetime for various materials.

FIG. 21 is a graph of spreading coefficient versus bubble lifetime for various materials, wherein the combination of a shell liquid comprising 10 wt % AQ™38 S, 0.5 wt % DYNOL™ 960 and 0.55 wt % SDS and a core liquid comprising 99 wt % MML and 1 wt % DOSS (OT) has a positive dynamic spreading coefficient and the other combinations do not.

FIG. 22 is a graph of the DVS sorption isotherms for various polymers.

FIG. 23 is a graph of: (i) surface tensions (SFT) for (a) a shell liquid comprising 10 wt % AQ™38 S, 0.5 wt % SDS and 0.5 wt % DYNOL™ 960, and (b) a core liquid comprising 99 wt % MML and 1 wt % DOSS; (ii) the interfacial tension (IFT) for the combination of (i)(a) and (i)(b); and (iii) the spreading coefficient (SC) for the combination of (i)(a) and (i)(b).

FIG. 24 is a graph of the surface tension for a shell liquid comprising 10 wt % AQ™ 38 S, 0.5 wt % SDS and 0.5 wt % DYNOL™ 960.

FIG. 25 is a graph of the surface tension for a core liquid comprising 99 wt % MML and 1 wt % DOSS.

FIG. 26 is a graph of the interfacial tension for the combination of: (i) a shell liquid comprising 10 wt % AQ™ 38 S, 0.5 wt % SDS and 0.5 wt % DYNOL™ 960; and (ii) a core liquid comprising 99 wt % MML and 1 wt % DOSS.

FIG. 27 is a graph of the spreading coefficient for the combination of: (i) a shell liquid comprising 10 wt % AQ™ 38 S, 0.5 wt % SDS and 0.5 wt % DYNOL™ 960; and (ii) a core liquid comprising 99 wt % MML and 1 wt % DOSS.

FIG. 28 is a table summarizing certain slopes annotated in FIGS. 24, 25, 26 and 27.

### DETAILED DESCRIPTION

Reference within the specification to “embodiment(s)” or the like means that a particular material, feature, structure and/or characteristic described in connection with the embodiment is included in at least one embodiment, optionally a number of embodiments, but it does not mean that all embodiments incorporate the material, feature, structure, and/or characteristic described. Furthermore, materials, features, structures and/or characteristics may be combined in any suitable manner across different embodiments, and materials, features, structures and/or characteristics may be omitted or substituted from what is described. Thus, embodiments and aspects described herein may comprise or be combinable with elements or components of other embodiments and/or aspects despite not being expressly exemplified in combination, unless otherwise stated or an incompatibility is stated.

All percentage and ratios are calculated by weight unless otherwise stated. All percentages and ratios are calculated based on the total composition unless otherwise stated.

All ranges are inclusive and combinable. Every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The number of significant digits conveys neither a limitation on the indicated amounts nor on the accuracy of the measurements. All numerical amounts are understood to be modified by the word “about” unless otherwise specifically indicated.

Unless otherwise indicated, all measurements are understood to be made at approximately 25° C. and at ambient conditions, where “ambient conditions” means conditions under about 1 atmosphere of pressure and at about 50% relative humidity.

“Benefit Agent” refers to the material, mixture or composition that forms at least part of a core of a microcapsule and provides an intended benefit to a target surface (e.g., skin, hair or fabrics) and/or delivers a benefit to a consumer.

“Benefit Agent Loading” refers to a weight average amount of benefit agent across a population of microcapsules measured using the Core Liquid Loading Test Method described herein.

“Bi-component Liquid Stream” refers to two liquid streams that are disposed in close proximity to one another. In some instances, the two liquid streams may be co-dispensed from a microfluidic device and/or are arranged in whole or partial contact with each other and/or are substantially concentric with respect to each another.

“Consumer Goods Composition” refers to any surfactant containing liquid composition intended for end use by a consumer.

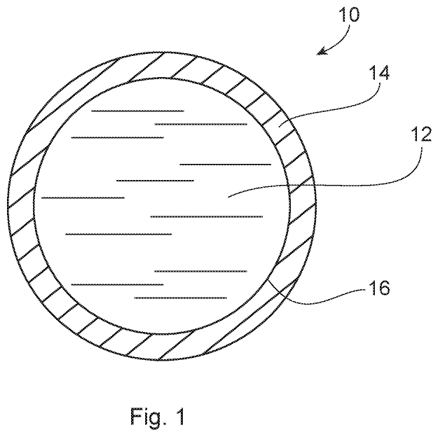

“Core” refers to the inner volume of a liquid droplet or microcapsule that is bounded completely or almost completely by either a liquid or solid shell. The core and shell share an interface that defines the boundary of each. A non-limiting example of a microcapsule 10 having a core 12, shell 14 and interface 16 is shown in FIG. 1. One skilled in the art will appreciate that the size and shape of the core, shell and interface can vary widely from the idealized version that is shown in FIG. 1 and that a shell may have voids, gaps or holes in it.

“Core Liquid” refers to the liquid used to form the core of a liquid droplet. The core liquid may be a mixture of liquids.

“Core Liquid Loading” refers to a weight average amount of core liquid across a population of microcapsules measured using the Core Liquid Loading Test Method described herein. If the core liquid is also the benefit agent (e.g., the core liquid consists of or consists essentially of a perfume oil or a sensate oil), then the Core Liquid Loading may be the same as the Benefit Agent Loading.

“Core/Shell Ratio” refers to the ratio of the weight of the core of a microcapsule to the weight of the shell of a microcapsule.

“Drying Gas” refers to the gas within the drying zone. The drying gas may or may not be heated.

“Drying Zone” refers to a gaseous zone within a drying chamber. In certain embodiments, the drying gas is heated to facilitate evaporation of water from the shell of the liquid droplets.

“Dynamic Interfacial Tension” refers to an interfacial tension value, IFT (mN/m), that has an absolute (i.e., with the sign omitted) instantaneous rate of change [symbol] IFT/ [symbol] (or line slope)>X at a particular time, T, wherein X is greater than 0.05 mN/m·s and T is the elapsed time from bubble formation (i.e., bubble surface age). In some instances, X may be greater than 0.5 mN/m·s, 1 mN/m·s, 2 mN/m·s or greater than 4 mN/m·s. In some instances, the interfacial tension is dynamic from time T=0.03 or 0.1 seconds to T=1, 0.75, 0.5 or 0.25 seconds.

“Dynamic Spreading Coefficient” refers to a spreading a coefficient value, S (mN/m), that has an absolute (i.e., with the sign omitted) instantaneous rate of change [symbol] / [symbol] (or line slope)>X at a particular time, T, wherein X is greater than 0.05 mN/m·s and T is the elapsed time from bubble formation (i.e., bubble surface age). In some instances, X may be greater than 0.5 mN/m·s, 1 mN/m·s, 2 mN/m·s, or 4 mN/m·s. In some instances, the spreading coefficient is dynamic from time T=0.03 or 0.1 seconds to T=1, 0.75, 0.5 or 0.25 seconds. Dynamic spreading coefficient values may be positive or negative.

“Dynamic Surface Tension” refers to a surface tension value, γ (mN/m), that has an absolute (i.e., with the sign omitted) instantaneous rate of change [symbol] / [symbol] (or line slope)>X at a particular time, T, wherein X is greater than 0.05 mN/m·s and T is the elapsed time from bubble formation (i.e., bubble surface age). In some instances, X may be greater than 0.5 mN/m·s, 1 mN/m·s, 2 mN/m·s, or 4 mN/m·s. In some instances, the surface tension is dynamic from time T=0.03 or 0.1 seconds to T=1, 0.75, 0.5 or 0.25 seconds.

“Dynamic Vapor Sorption” (DVS) refers to how much water is absorbed by a material sample according to the DVS Water Sorption Test Method described herein.

“Flammable” refers to a material having a flash point below 38° C.

“Interfacial tension” refers to the surface tension (mN/m) at a surface separating two non-miscible liquids. Interfacial tension is measured using the IFT Test Method described herein.

“Liquid” refers to a nearly incompressible fluid that conforms to the shape of its container but retains a (nearly) constant volume independent of pressure. Some materials (e.g., shell liquid) may be a liquid under some conditions and a solid under others. For example, a material is preferably a liquid when flowing thru a microfluidic device but may become a solid during or after microcapsule formation.

“Liquid Droplet” refers to a discrete liquid or semi-liquid volume bounded completely or almost completely by a free surface. Liquid droplets may or may not be substantially spherical. A liquid droplet has a core comprising one or more liquids surrounded by a shell comprising one or more liquids. In some instances, the core of the liquid droplet is formed substantially or completely from liquids and the shell of the liquid droplet is formed substantially or completely from liquids. In some instances, the core, the shell or both may also contain solid materials.

“Microcapsule” refers to a core-shell particle having a solid or semi-solid shell bounding or encapsulating a core comprising one or more liquids and having a mean, equivalent diameter of less than 150 μm, or less than 100 μm, or less than 75 μm or less than 50 μm. Microcapsules may have any shape, including spherical or irregular.

“Microfluidic Device” refers to a device having one or more fluid channels having a cross-sectional dimension less than 1 mm, or less than 900 microns, or less than 800 microns or less than 600 microns or less 400 microns, or less than 300 microns through which the core liquid and/or the shell liquid flow and/or exit the device to form liquid droplets. The cross-sectional dimension need not be constant through the entire length of a fluid channel.

“Micro-Liquid Droplets” refers to liquid droplets having a mean diameter of less than 350 μm, 250 μm or less than 100 μm, or less than 75 μm or less than 50 μm measured approximately 5 cm from the exit of the device. The liquid droplet diameter may be measured using optical microscopy.

“Oil” refers to any hydrophobic liquid. An oil may be derived from any animal, plant or mineral source. An oil may be volatile or non-volatile.

“Rayleigh Break-up” refers to a liquid stream, including a bi-component liquid stream, which breaks-up into liquid droplets due to Rayleigh instability. Rayleigh break-up is characterized by liquid droplets having a diameter larger than the stream diameter and the break-up occurring further downstream of the exit compared to first wind induced, second wind induced and atomization. Some non-limiting examples of Rayleigh Break-up, First Wind Induced, Second Wind Induced and Atomization are shown in Erriguible et al., Numerical investigations of liquid jet breakup in pressurized carbon dioxide: Conditions of two phase flow in supercritical antisolvent process, J. of Supercritical Fluids 63, p 17 (2012).

“Shell” refers to the outer portion or layer of a liquid droplet or a microcapsule. One non-limiting example of a microcapsule illustrating a core and shell is shown in FIG. 1.

“Shell Liquid” refers to a liquid used to form the shell of a liquid droplet. The shell liquid may a mixture of liquids.

“Shell Liquid/Core Liquid Flow Rate Ratio” refers to the ratio of the volumetric flow rate of the shell liquid to the volumetric flow rate of the core liquid through a liquid droplet forming device, such as, for example, a microfluidic device.

“Spreading Coefficient” refers to the measure of the ability of a liquid to spread on the surface of another liquid. Spreading coefficient is defined by the formula:

S=γ_{CORE}−γ_{SHELL}−γ_{INTERFACIAL}

wherein S=The spreading coefficient value (mN/m);
γ_{CORE}=The surface tension of the core liquid (mN/m);
γ_{SHELL}=The surface tension of the shell liquid (mN/m); and
γ_{INTERFACIAL}=The interfacial tension between the core liquid and the shell liquid (mN/m).
   Spreading coefficient may be dynamic or steady state and positive or negative and is measured and calculated using the Spreading Coefficient Test Method described herein.

“Steady State Interfacial Tension” refers to an interfacial tension value, IFT (mN/m), having an absolute (i.e., with the sign omitted) instantaneous rate of change [symbol] FT/ [symbol] (or line slope)=Y at a particular time, T, wherein Y is between 0 and 0.05 and T is the elapsed time from bubble formation (i.e., bubble surface age). In some instances, the interfacial tension is steady state at T>1, 1.5, 2, 5 or 10 seconds.

“Steady State Spreading Coefficient” refers to a spreading coefficient value, S (mN/m), having an absolute (i.e., with the sign omitted) instantaneous rate of change [symbol] / [symbol] (or line slope)=Y at a particular time, T, wherein Y is between 0 and 0.05 mN/m·s and T is the elapsed time from bubble formation (i.e., bubble surface age). In some instances, the spreading coefficient is steady state at T>1, 1.5, 2, 5, or 10 seconds.

“Steady State Surface Tension” refers to a surface tension value having an absolute (i.e., with the sign omitted) instantaneous rate of change [symbol] / [symbol] (or line slope)=Y at a particular time, T, wherein Y is between 0 and 0.5 mN/m·s and T is the elapsed time from bubble formation (i.e., bubble surface age). In some instances, the surface tension is steady state at T>1, 1.5, 2, 5, or 10 seconds. Steady state surface tension values may be positive or negative.

“Substantially Free” means a material is present at concentration of less than 2%, 1%, 0.5%, 0.1%, 0.01% or 0.001% by weight of the shell, core, liquid droplet or microcapsule as dictated by the context.

“Surface Tension” refers to the elastic tendency of a liquid that tends to minimize the surface area of the liquid. Surface tension values may be either dynamic or steady state positive or negative and is measured using the Surface Tension Test Method described herein.

“Viscosity Modifier” refers to a material (or materials) that reduces the viscosity of the core liquid to less than 200 centipoise (cP), 150 cP or 100 cP.

“Water Absorbing Polymer” refers to a polymer having a DVS sorption value greater than 3%, 5%, 6%, 7% or 8% at 80% relative humidity and 30° C.

Various methods and systems will now be described in which liquid droplets are formed and water is evaporated from the liquid droplets to form microcapsules.

### I. Systems for Forming Liquid Droplets and Core-Shell Microcapsules

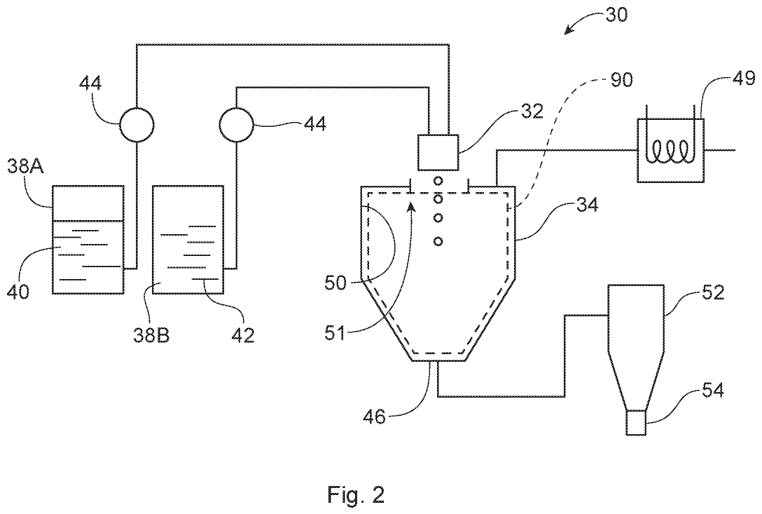

Referring to FIG. 2, one non-limiting example of a system 30 for forming liquid droplets and microcapsules is illustrated. The system 30 comprises a liquid droplet forming device 32, a drying chamber 34, one or more liquid reservoirs 38 (two being shown, 38a and 38b) for storing the core liquid 40 and the shell liquid 42 to be provided to a liquid droplet forming device 32 by pumps 44. The liquid droplet forming device 32 produces a plurality of liquid droplets comprising the core liquid 40 and the shell liquid 42. In certain embodiments, the liquid droplet forming device produces a bi-component liquid stream which undergoes Rayleigh Break-up to form the plurality of liquid droplets.

Following collection of the microcapsules, some or all of the collected microcapsules may be subjected to further processing as known in the art (e.g., sieving, coating, dispersion into other liquids, admixing with other powders, etc.), after which the microcapsules may be incorporated into a consumer goods composition or an article of manufacture, such as, for example, a web, non-woven or other substrate.

a. Liquid Droplet Forming Devices

The liquid droplet forming device 32 may be provided in a variety of forms. In some instances, it may be desirable to maximize the flow rate of the core liquid compared to the shell liquid in order to form liquid droplets and microcapsules that maximize, rather than minimize, the core-shell ratio and therefore the amount of benefit agent delivered per microcapsule. The shell liquid/core liquid flow rate ratio through the liquid droplet forming device may be less than 30:1, 20:1, 10:1, 8:1, 6:1, 4:1, 3:1 or 2:1. The liquid droplet forming device typically comprises a housing, one or more (typically two) inlets to receive the core liquid and the shell liquid and one or more channels, passages or tubes within the housing for transporting the core liquid and the shell liquid within the device. The device also comprises one or more exits from which the core liquid and the shell liquid are discharged. Preferably, the core liquid and the shell liquid are discharged as a bi-component liquid stream from co-axial exits. The device may or may not utilize pressurized air or other means to assist with liquid droplet formation. For example, in certain embodiments, the device may comprise an inlet for receiving a pressurized gas and an exit for the same near or adjacent to the exits for the core liquid and/or the shell liquid. Alternatively or in addition thereto, the liquid droplet forming device may be connected to an electrical power supply and utilize a transducer (e.g., a piezoelectric transducer or the like) or other electrically driven, vibrating surface to assist with forming the liquid droplets (e.g., model ACCUMIST™ available from Sonotek, Inc.).

While a variety of liquid droplet forming devices may be utilized, a microfluidic device is preferred in order to achieve more uniform liquid droplet/microcapsule sizes/distributions. Some non-limiting examples of microfluidic devices will be described hereafter for purposes of illustration. In some instances, one or more of the channels of a microfluidic device may have an exit, or the microfluidic device may have an exit, with a cross-sectional dimension from about 10 microns, 50 microns or 200 microns to about 300 microns, about 400 microns, about 600 microns, about 800 microns, about 900 microns or about 1 mm. Due to the small channel dimension and/or exit dimension that may be employed in a microfluidic device, it may be desirable for the shell liquid and/or the core liquid to have a viscosity less than 200 centipoise (cP), 150 cP, 125 cP or 100 cP. One or more viscosity modifiers may sometimes be added to one or both of these liquids in order to reduce their viscosity to a desired level, so long as the dynamic spreading coefficient is greater than zero.

The flow rate of a core liquid through a channel of a microfluidic device may be greater than 2 ml/hr, 4 ml/hr, 6 ml/hr, 8 ml/hr, 10 ml/hr or 12 ml/hr and/or less than 150 ml/hr, 125 ml/hr, 100 ml/hr or less than 80 ml/hr. In some instances, the flow rate of the core liquid through a channel of a microfluidic device is from about 2 ml/hr to about 150 ml/hr. The flow rate of the shell liquid thru a channel of the microfluidic device may be greater than 5 ml/hr, 10 ml/hr, 15 ml/hr, 30 ml/hr, 40 ml/hr, or 50 ml/hr and/or less than about 450 ml/hr, 250 ml/hr, or 100 ml/hr. In some instances, the flow rate of the shell liquid through a channel of a microfluidic device may be from about 30 ml/hr to about 450 ml/hr. A bi-component liquid stream exiting a microfluidic device may break-up into liquid droplets in less than 0.75 milliseconds, less than 0.5 milliseconds or less than 0.3 milliseconds after exiting a microfluidic device. The liquid droplets typically formed from a microfluidic device are micro-liquid droplets. In some embodiments, the bi-component liquid stream undergoes Rayleigh Break-up to from a stream of liquid droplets. It is presently believed that Rayleigh Break-up balances (as compared to first wind induced, second wind induced or atomization regimes) core/shell liquid throughput, liquid droplet size control and liquid droplet morphology.

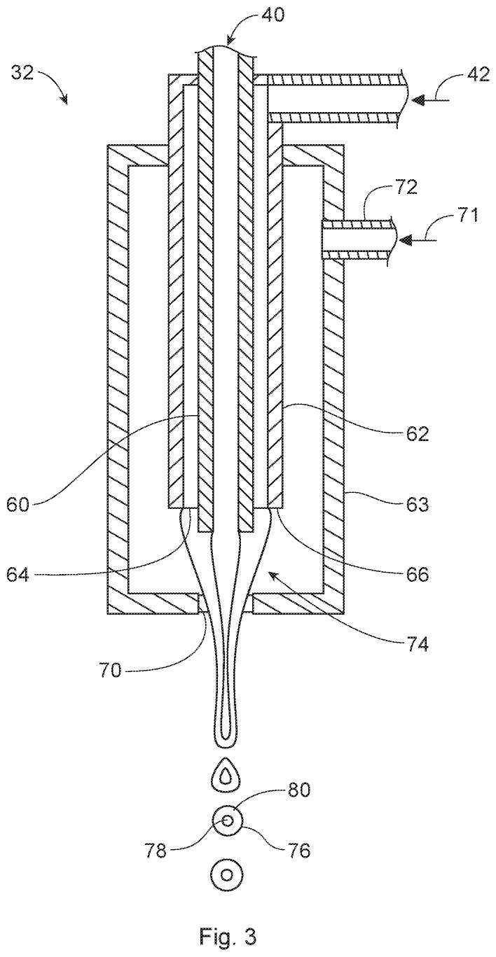

Referring to FIG. 3, one non-limiting example of a microfluidic device 32 using a gas to break-up a bi-component liquid stream will now be described. The device 32 comprises a first channel, preferably a first capillary tube 60, through which a core liquid flows. The device 32 further comprises a second channel, preferably a second capillary tube 62, through which a shell liquid flows. In some instances, the second capillary tube 62 is concentric with the first capillary tube 60 and the exits 64, 66 of the first and second capillary tubes are substantially concentric. In some instances, a pressurizing chamber 63 may surround the first and second capillary tubes and have an exit 70 downstream of the exits 64, 66 of the first and second capillary tubes. The exit 70 may be in the form of a small hole having a diameter from 0.005 mm to 1.0 mm and is located from 0.0002 mm to 5 mm downstream of the concentric exits 64, 66. A pressurizing gas 71, such as ambient air, may be delivered to the pressurizing chamber 63 by conduit 72. The pressurizing gas surrounds the bi-component liquid stream 74 exiting the first and second capillary tubes 60, 62 and contributes to the breakup of the bi-component liquid stream 74 into a stream of liquid droplets 76, one example of such break-up being shown in FIG. 3. Each of the liquid droplets 76 comprises a core 78 formed from the core liquid and a shell 80 formed from the shell liquid that surrounds the core 78. Additional description of such a microfluidic device may be found in Banderas et al., “Flow Focusing: A Versatile Technology to Produce Size-Controlled and Specific-Morphology Microparticles”, Small (2005) and/or one or more of U.S. Publ. Nos.: 2007/0102533; 2009/0215154 and 2009/0214655. Examples of the microfluidic device 32 are also available from Ingeniatrics Tecnologias, S.L.

In use, a bi-component liquid stream exits the capillary tubes of the device 32 and is accelerated and stretched by the pressurizing gas, resulting in reduction of the diameter of the bi-component liquid stream. Upon exiting the device 32, the bi-component liquid stream begins to break-up as it decelerates, Rayleigh instability sets in and the pressurized gas also exiting the device 32 diffuses. In this particular microfluidic device, the time period from when the liquid bi-component stream exits the capillary tubes to break-up of the bi-component liquid stream into liquid droplets may be less than about 0.5 milliseconds.

b. Drying Chambers

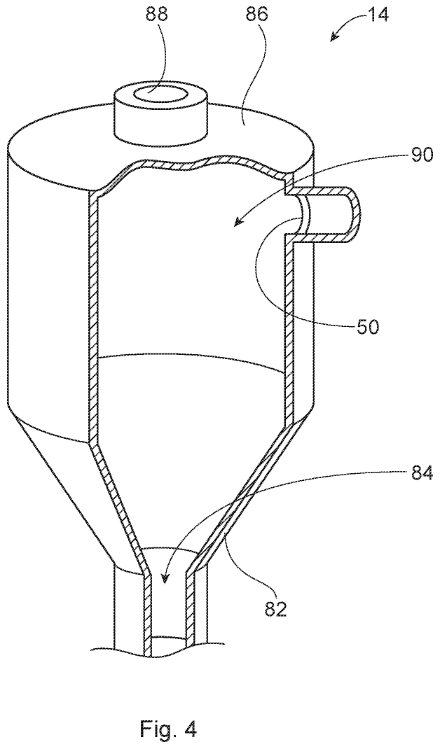

Referring to FIG. 4, the drying chamber 14 may be provided in a wide variety of shapes, sizes and configurations. The drying chamber may be also referred to as a spray dryer in the art, and various models are available from manufactures such as the GEA Group. The drying chamber 14 utilizes a turbulent gas (typically ambient air or heated air) to evaporate water from the shell liquid. A heater 49 (FIG. 2) may be provided to heat the drying gas introduced into the drying chamber. The heater 49 is in gaseous communication with the drying chamber. Heater 49 is shown for purposes of illustration as an electrically resistive heater. The drying chamber 14 may be disposed downstream of the liquid droplet forming device 12 or the liquid droplet forming device 12 may be disposed partially or wholly within the drying chamber 34. At least some of, and preferably substantially all of, the water is evaporated from the shells of the liquid droplets. In some instances, the Reynolds number of the gas entering the drying chamber 34 via a conduit may be greater than 2,000, 2,500, 3,000 or 5,000. In some instances, the gas is introduced in a swirling manner via an annulus located at the top of the drying chamber. If the gas is introduced into the drying chamber in a swirling manner, the gas will have both radial and axial velocities components. The gas within the drying chamber may also produce recirculation zones, swirling and rotation, and/or eddies, due in part to a conical shaped bottom of the drying chamber. Some examples of swirling gases, recirculation zones and/or eddies in a spray drying chamber is shown and/or described in D. F. Fletcher, et al., “What is important in the simulation of spray dryer performance and how do current CFD models perform”, Applied Mathematical Modeling, 30, pp 1281-1292, (2006). In some instances, the drying chamber may be a “pull” type design, wherein a vacuum is applied to the exit of the drying chamber to draw the gas within the chamber downward toward the exit.

In some embodiments, the drying chamber 14 is cylindrically shaped and comprises a side wall 90, a conically shaped bottom wall 82 having the exit 84 and a top wall 86 having one or more openings 88 therein. The opening 88 may be used to receive one or more liquid droplet forming devices 12. In some instances, the drying chamber has a concurrent flow (e.g., the direction of the drying gas and bi-component liquid stream are in the same direction). The walls enclose an interior volume of the drying chamber 34 that is considered to be the drying zone. In some instances, the interior volume of the drying chamber 14 may be from about 1 m³ to about 250 m³ or from about 1 m³ to about 100 m³ or from about 1 m³ to about 25 m³, and the drying chamber may have a height from about 4 meters to about 25 meters and a width from about 1 meter to about 10 meters. The drying gas may tangentially enter the interior of the drying chamber 14 from the side wall 90 of the drying chamber 14 through opening 50. In other embodiments, the gas may enter in a downwardly directed swirling motion from an annulus in the top wall 86 (depicted schematically in FIG. 2). Some non-limiting examples of drying chambers suitable for use include those made by the GEA Group (Germany).

### II. Core and Shell Materials

Without intending to be bound by any theory, it is believed to be highly desirable for the liquid droplets to have a dynamic spreading coefficient that is greater than zero when forming microcapsules in a turbulent drying chamber. The dynamic spreading coefficient of the liquid droplets may be calculated from the dynamic surface tensions of the core liquid and the shell liquid and the dynamic interfacial tension between them. While steady state spreading coefficient is widely discussed in the art, it is believed that a dynamic spreading coefficient greater than zero may be a more important consideration for successful formation of liquid core microcapsules in conventional spray dryers due to the short time over which the liquid droplets (particularly micro-liquid droplets) have to successfully form once a bi-component liquid stream has broken up.

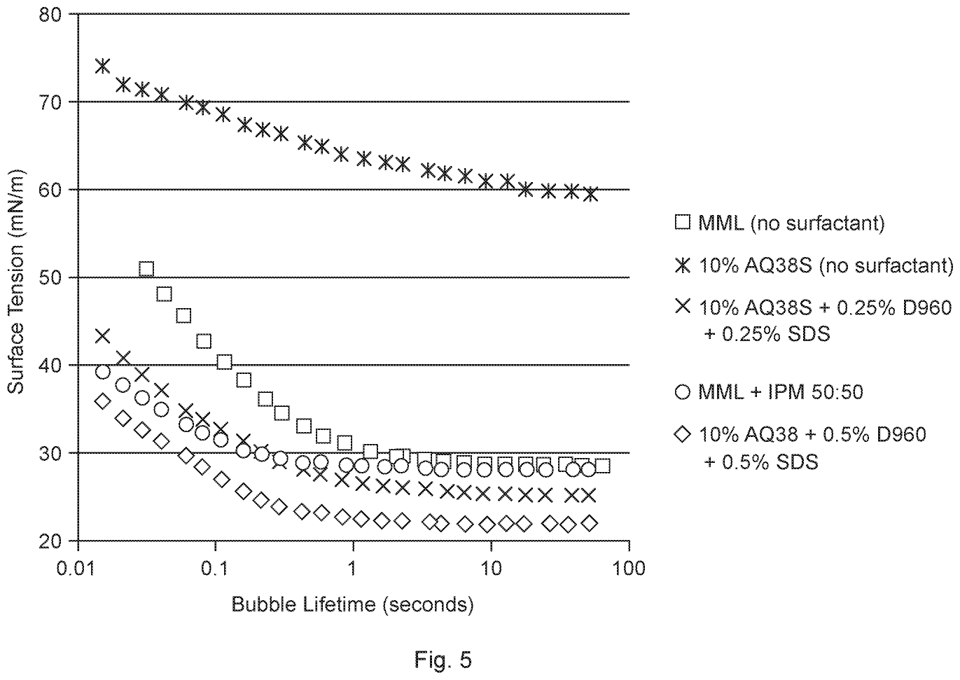

The shell liquid and/or the core liquid comprise one or more surfactants to achieve the desired surface tension values that result in a dynamic spreading coefficient greater than zero. Sometimes, depending on the nature of the core liquid and the shell liquid, it may be desirable to include 2 or more surfactants: one or more for lowering the dynamic interfacial tension and one or more for lowering the dynamic surface tension of the shell liquid. In some instances, the one or more surfactants reduce the dynamic surface tension of the shell liquid by greater than 25%, 30%, 35%, 40%, 45%, 50%, 55% and or 60% at T=0.03, 0.1, 0.25, 0.5, 0.75 and/or 1 seconds of the bubble surface age. In some instances, the one or more surfactants reduce the dynamic surface tension of the shell liquid by greater than 40% or 50% at T=0.1 second of the bubble surface age. One example of a dynamic surface tension reduction is shown in FIG. 5, wherein the surface tension values for 10 wt % Eastman AQ™38 S in water (without surfactants) are greater than the surface tension values for 10 wt % AQ™38 S in water in combination with 0.5 wt % sodium dodecyl sulfate (SDS) and 0.5 wt % DYNOL™ 960 (D960), both of which are surfactants.

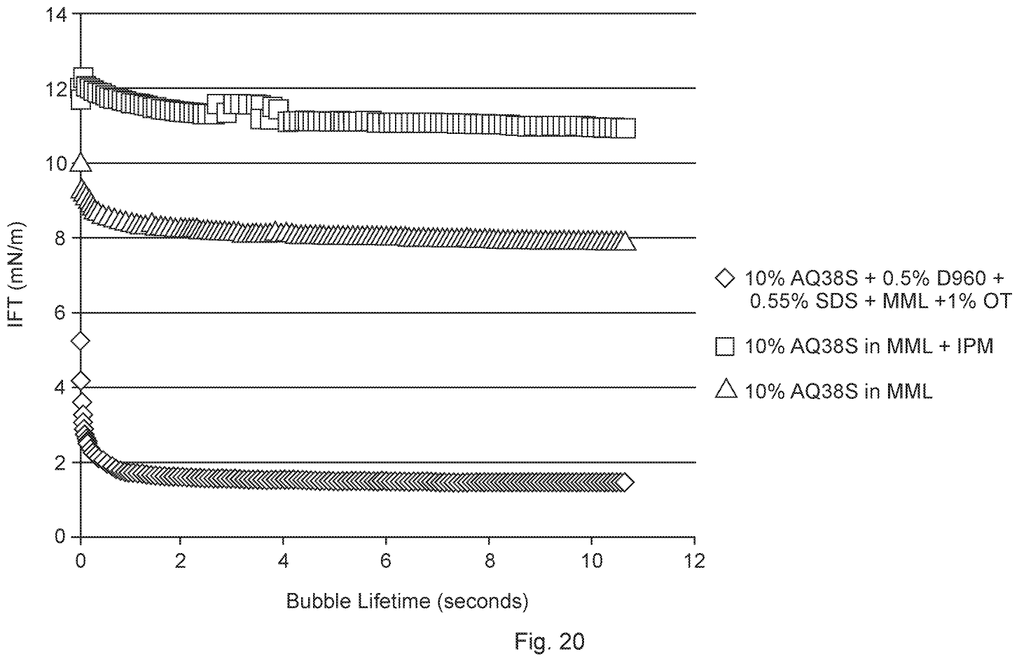

Without intending to be bound by any theory, it is presently believed that the dynamic interfacial tension should be low enough to contribute to a dynamic spreading coefficient greater than zero but not too low that the core liquid becomes miscible in the shell liquid of the liquid droplet (i.e., interfacial surface tension equal greater than zero). In some instances, the dynamic interfacial surface tension is greater than 0, 0.25, 0.5, or 1 mN/m and/or less than 12, 10, 5, 3, 2 or 1 mN/m at T=0.03, 0.1, 0.25, 0.5 0.75 and/or 1 second of the bubble surface age. In some instances, the one or more surfactants reduce the dynamic interfacial tension between the shell liquid and the core liquid (as compared to a shell liquid without the surfactant(s) with the wt % of surfactant being replaced by water, and a core liquid without the surfactant(s) with the wt % of surfactant being replaced by the oil of the core liquid) by greater than 40%, 50%, 60%, or 70% at T=0.03, 0.1, 0.25, 0.5, 0.75 and/or 1 second of the bubble surface age. In some instances, the one or more surfactants reduce the dynamic interfacial tension between the shell liquid and the core liquid by greater than 40% or 50% at T=0.1 second of the bubble surface age. One example of a dynamic interfacial tension reduction is shown in FIG. 20, wherein the interfacial tension values for a combination of a shell liquid comprising 10 wt % Eastman AQ™38 S in water (without surfactants) and a core liquid comprising MML are greater than the interfacial tension values for a combination of a shell liquid comprising 10 wt % AQ™38 S in water with 0.55 wt % SDS and 0.5 wt % DYNOL™ 960 and a core liquid comprising 99 wt % MML with 1 wt % DOSS (OT).

a. Dynamic Spreading Coefficient, Dynamic Surface Tension and Dynamic Interfacial Tension

According to one aspect of invention, the core liquid and the shell liquid have a dynamic spreading coefficient greater than zero. In some instances, the dynamic spreading coefficient is greater than zero at T=0.03, 0.1, 0.25, 0.5, 0.75 and/or 1 second of bubble surface age. In some instances, the core liquid and the shell liquid have a dynamic spreading coefficient great than zero from about 0.03 seconds to about 1 second of bubble surface age. In some instances, the dynamic spreading coefficient may be greater than 0, 2.5, 5, 7.5, 10, 15, or 20 mN/m during at least some of these time periods. For example, the dynamic spreading coefficient might be greater than 10 mN/m at T=0.1 seconds and greater than 0 or 5 mN/m at T=0.25, 0.75 and 1 second of bubble surface age.

Incorporating one or more surfactants in the shell liquid and, optionally the core liquid, used to form the liquid droplets may assist in providing a dynamic spreading coefficient greater than zero within time periods that enable rapid envelopment or spreading of the shell liquid about the core liquid during liquid droplet formation. It is believed that rapid envelopment of the core liquid by the shell liquid during formation of the liquid droplets may contribute to core-shell ratios greater than 2.5:1, 3:1, 4:1 by weight of the microcapsule. In some instances, the microcapsule comprises greater than 10%, 20%, 30%, of one or more oils by weight of the microcapsule, as determined by thermogravimetric analysis averaged across a population of microcapsules. In some instances, the core liquid consists essentially of or consists of just the one or more oils. In some instances, the core liquid comprises greater than 50%, 80%, 90%, 95%, or 99% by weight of one or more oils.

More than one surfactant may be incorporated in the shell liquid, wherein one of the surfactants decreases the surface tension of the shell liquid and the other surfactant decreases the interfacial tension between the core liquid and the shell liquid. The surfactant that lowers the interfacial tension may be added to the core liquid and/or the shell liquid. The shell liquid may comprise from about 0.1%, 0.2% or 0.3% to about 3%, 2%, 1% or 0.5% of one or more surfactants by weight of the shell liquid. In some instances, the shell liquid comprises from about 0.3% to about 1% by weight of the one or more surfactants. The core liquid may comprise from about 0.1%, 0.2% or 0.3% to about 2%, 1% or 0.5% of one or more surfactants by weight of core liquid. In some instances, the core liquid comprises from about 0.3% and about 1% by weight of the one or more surfactants.

In some instances, the shell liquid may have a dynamic surface tension less than 50, 40 or 30 mN/m at T=0.03, 0.1, 0.25, 0.5 and/or 1 second of bubble surface age. In some instances, the dynamic surface tension of the shell liquid may be between about 25 mN/m and about 45 mN/m at T=0.1 seconds and/or between about 25 mN/m and about 30 mN/m at T=1 second of bubble surface age.

In some instances, the core liquid may have a dynamic surface tension greater than 20 mN/m, 30 mN/m, 40 mN/m or greater than 50 mN/m at T=0.03, 0.1, 0.25, 0.5, 0.75 and/or 1 second of bubble surface age. In some instances, the dynamic surface tension of the core liquid may be between about 30 mN/m and about 45 mN/m at T=0.1 seconds and/or between about 28 mN/m and about 32 mN/m at T=1 second of bubble surface age. The lower the dynamic surface tension of the core liquid at a given time T, the lower the dynamic surface tension of the shell liquid and/or the dynamic interfacial tension will need to be at time T in order to provide a dynamic spreading coefficient value greater than zero. More preferably, the difference between the dynamic surface tension of the core liquid and the dynamic surface tension of the shell (difference=γ_{CORE}−γ_{SHELL}) at a given time T of bubble surface age is greater than +1, +2, +4, +6, +8 or +10 mN/m.

FIGS. 5 to 18 illustrate shell liquid surface tensions for various combinations of surfactants, water and either AQ™38 (a sulfopolyester available from Eastman Chemical Company) or EASTEK™ 1200 polyester (available from the Eastman Chemical Company), which is an aqueous dispersion comprising 2% by weight n-propanol and 30% by weight of polymer solids, or PLASCOAT™ Z-687 available from Goo Chemical Co., Ltd. (Japan).

FIG. 5 illustrates the surface tension curves for: a mixture comprising 50 wt % of 1-menthol available from Symrise AG and 50 wt % menthyl lactate, also available from Symrise AG, this 50:50 combination being referred to herein as MML; 10% by weight Eastman AQ™ 38 S (a polyester from Eastman Chemical Co.) and balance water; 10% by weight Eastman AQ™38 S, 0.25% by weight DYNOL™ 960 (a non-ionic, siloxane based super-wetting surfactant) available from Air Products and Chemicals, Inc., and 0.25% sodium dodecyl sulfate (a surfactant, sometimes referred to as SDS) available from Sigma-Aldrich GmbH, and balance water; and 10% by weight Eastman AQ™ 38 S, 0.5% by weight DYNOL™ 960, 0.5% SDS, and balance water; and 50 wt % of MML and 50 wt % of iso-propyl myristate (IPM).

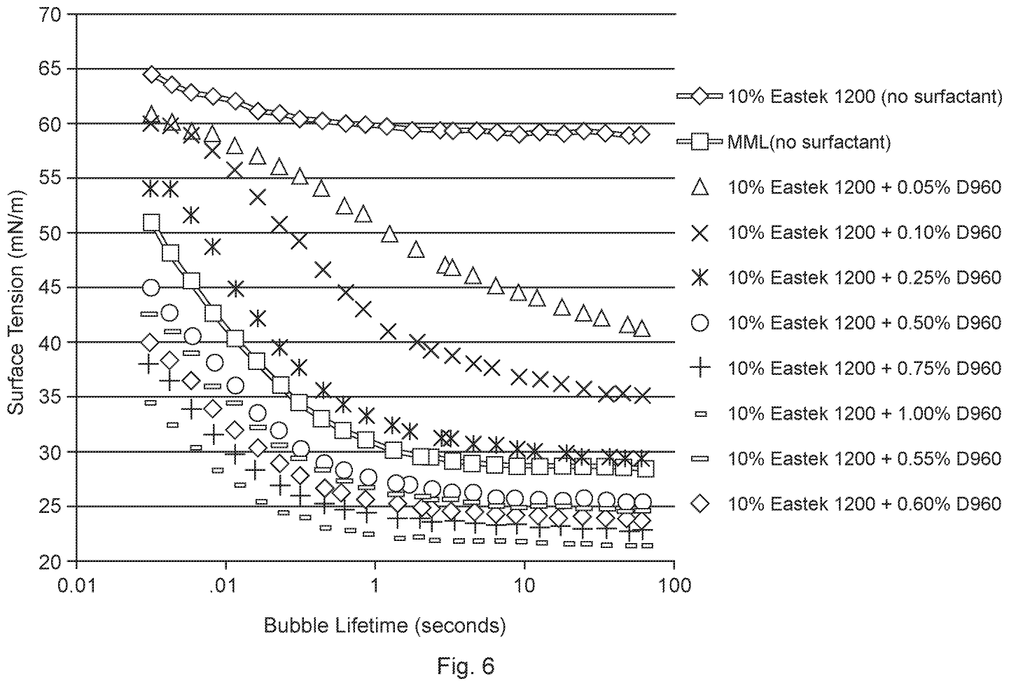

FIG. 6 illustrates the surface tension curves for 10% by weight of EASTEK 1200 and water (no surfactants), 10% by weight of EASTEK™ 1200 and various weight percentages (0.05 wt % to 1 wt %) of DYNOL™ 960 with the balance being water, and MML (one example of a core liquid).

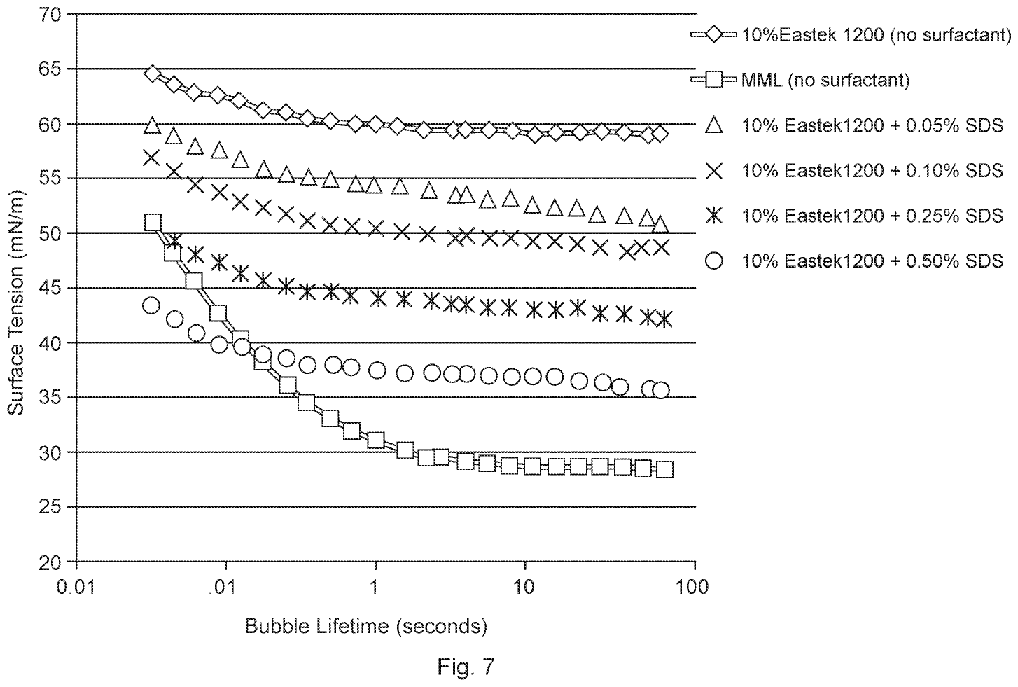

FIG. 7 illustrates the surface tension curves for 10% by weight of EASTEK™ 1200 and water (no surfactants), 10% by weight of EASTEK™ 1200 and various weight percentages (0.05 wt % to 0.5 wt %) of SDS with the balance being water, and MML (one example of a core liquid).

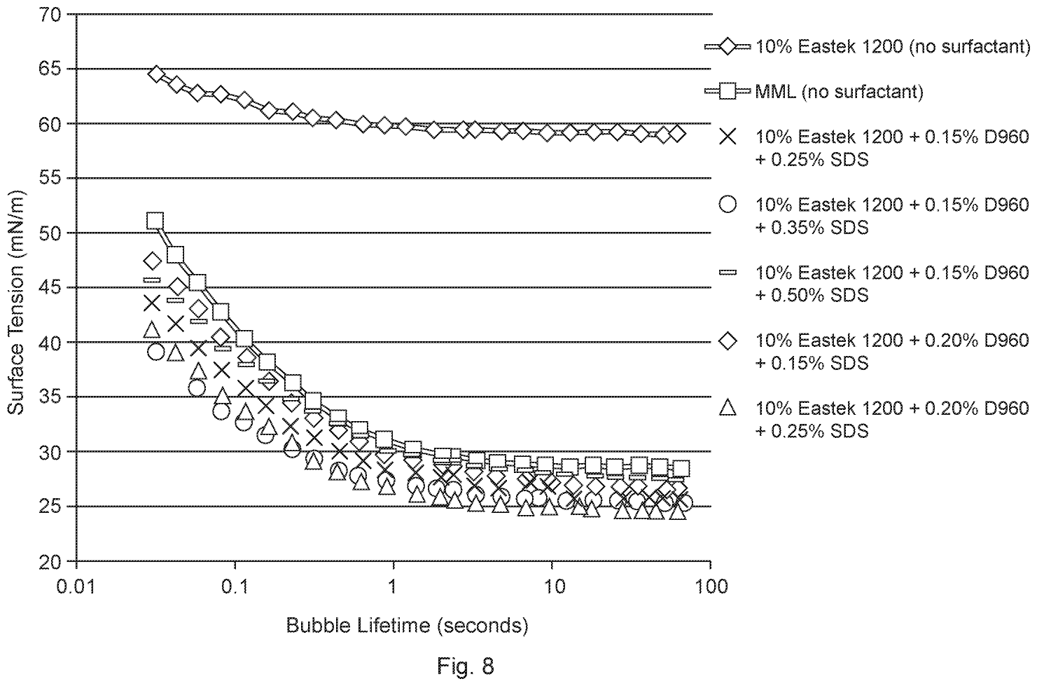

FIG. 8 illustrates the surface tension curves for 10% by weight of EASTEK™ 1200 and water (no surfactants), 10% by weight of EASTEK™ 1200 and one or more of SDS (0.15 wt % to 0.5 wt %) and DYNOL™ 960 (0.25 wt % to 0.3 wt %) with the balance being water, and MML (one example of a core liquid).

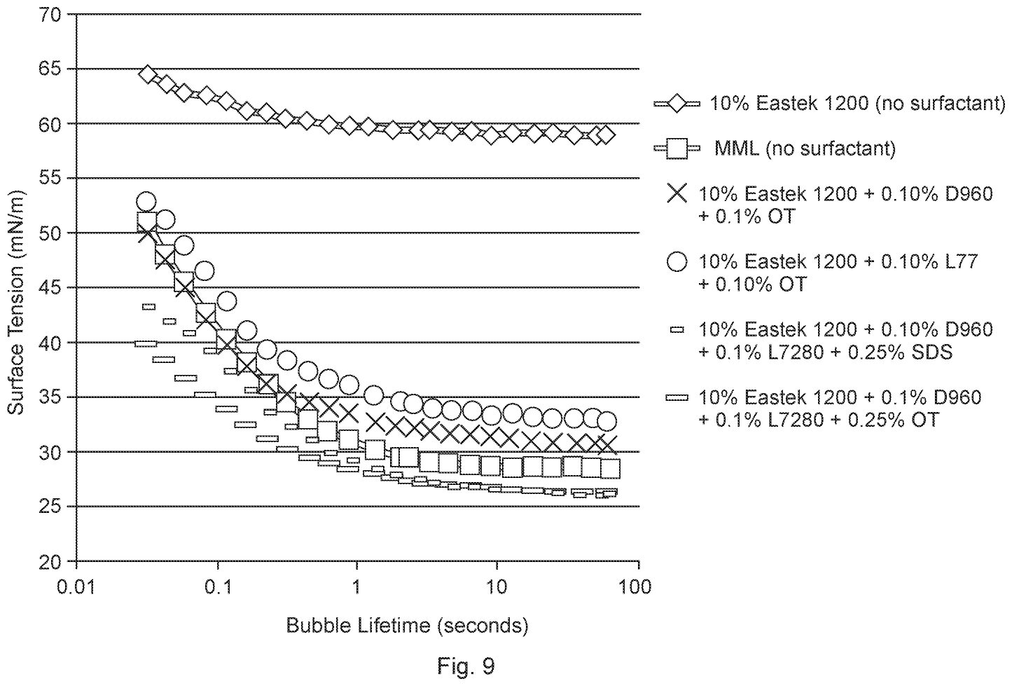

FIG. 9 illustrates the surface tension curves for 10% by weight of EASTEK™ 1200 and water (no surfactants); 10% by weight of EASTEK™ 1200 and one or more of SDS and/or DYNOL™ 960 (0.1 wt %) and/or SILWET® L-77 (0.1 wt % or 0.25 wt %), a polyalkyleneoxide modified heptamethyltrisiloxane surfactant available from Momentive Performance Materials, and/or SILWET® L-7280 (0.1 wt %), a polyalkyleneoxide modified heptamethyltrisiloxane surfactant available from Momentive Performance Materials, and/or sodium dioctyl sulfosuccinate (0.1 wt % or 0.25 wt %), also referred to as DOSS (available from Cytec Industries, Inc. under the name AEROSOL™ OT) with the balance being water; and MML (one example of a core liquid).

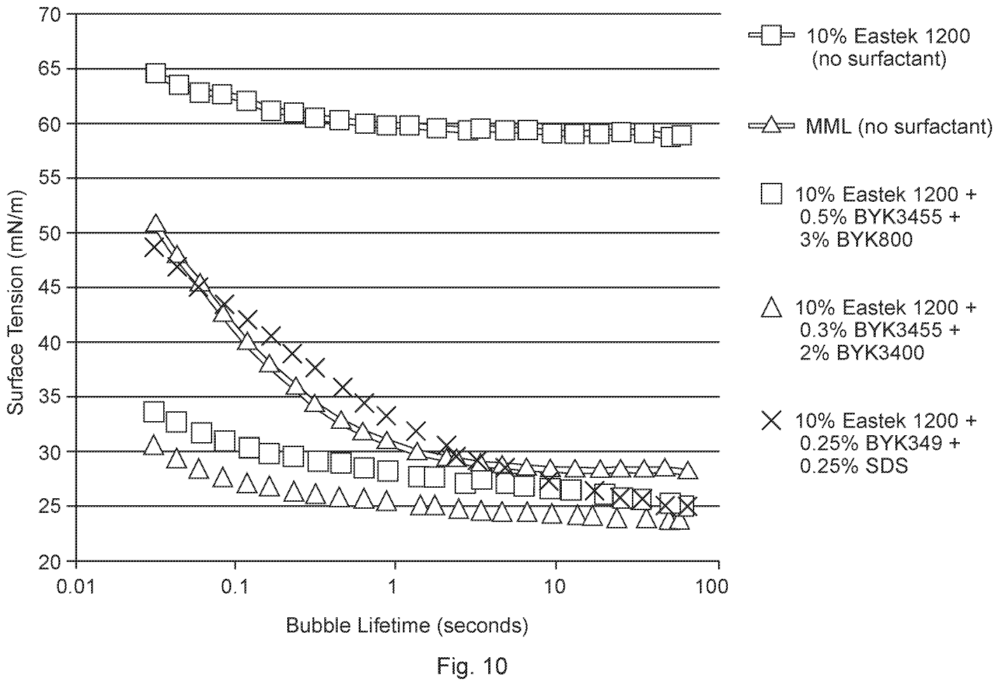

FIG. 10 illustrates the surface tension curves for 10% by weight of EASTEK™ 1200 and water (no surfactants); 10% by weight of EASTEK™ 1200 and one or more of SDS (0.25 wt %) and/or BYK-349, a polyether modified siloxane surfactant available from BYK USA, Inc., and/or BYK-3455, a polyether modified polydimethylsiloxane available from BYK USA, Inc., and/or BYK-800, a silicone free surfactant comprising alcohol alkoxylates available BYK USA, Inc., and/or BYK-3400, a surfactant available from BYK USA, Inc., and/or DOSS (OT); and MML (one example of a core liquid).

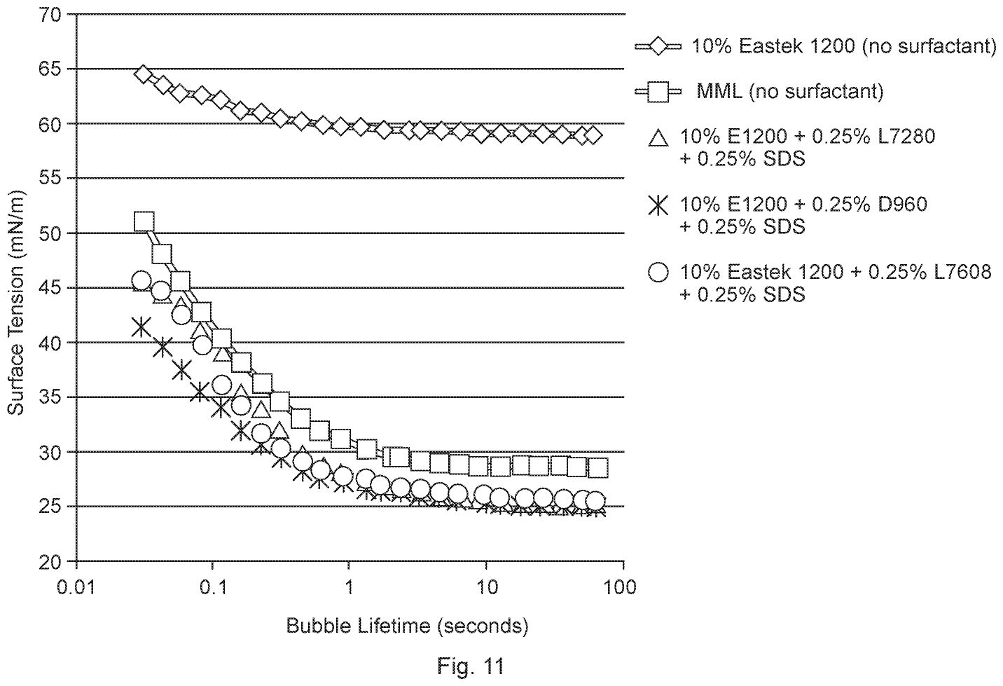

FIG. 11 illustrates the surface tension curves for 10% by weight of EASTEK™ 1200 and water (no surfactants); 10% by weight of EASTEK™ 1200 and one or more of SILWET® L-7280, a polyalkyleneoxide modified heptamethyltrisiloxane surfactant available from Momentive Performance Materials, and/or SDS (0.25 wt %); and MML (one example of a core liquid).

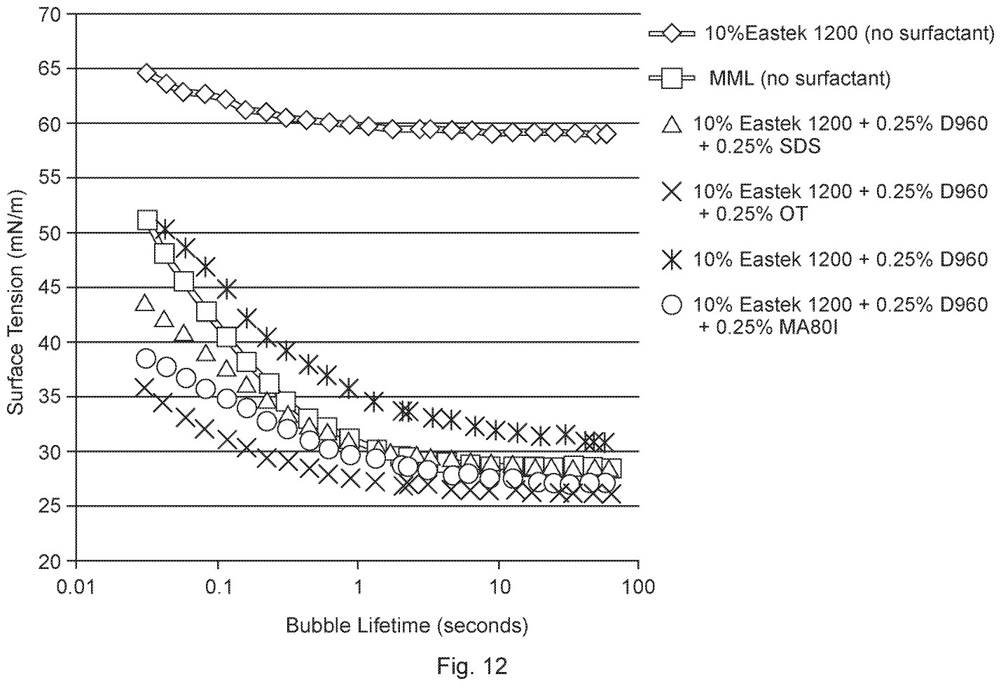

FIG. 12 illustrates the surface tension curves for 10% by weight of EASTEK™ 1200 and water (no surfactants); 10% by weight of EASTEK™ 1200 and one or more of SDS (0.25 wt %) and/or DYNOL™ 960 (0.25 wt %) and/or DOSS (0.25 wt %) and/or AEROSOL™ MA80L (0.25 wt %), and/or AEROSOL™ MA80, a sodium dihexyl sulfosuccinate containing surfactant available from Cytec Industries, Inc.; and MML (one example of a core liquid); and MML (one example of a core liquid).

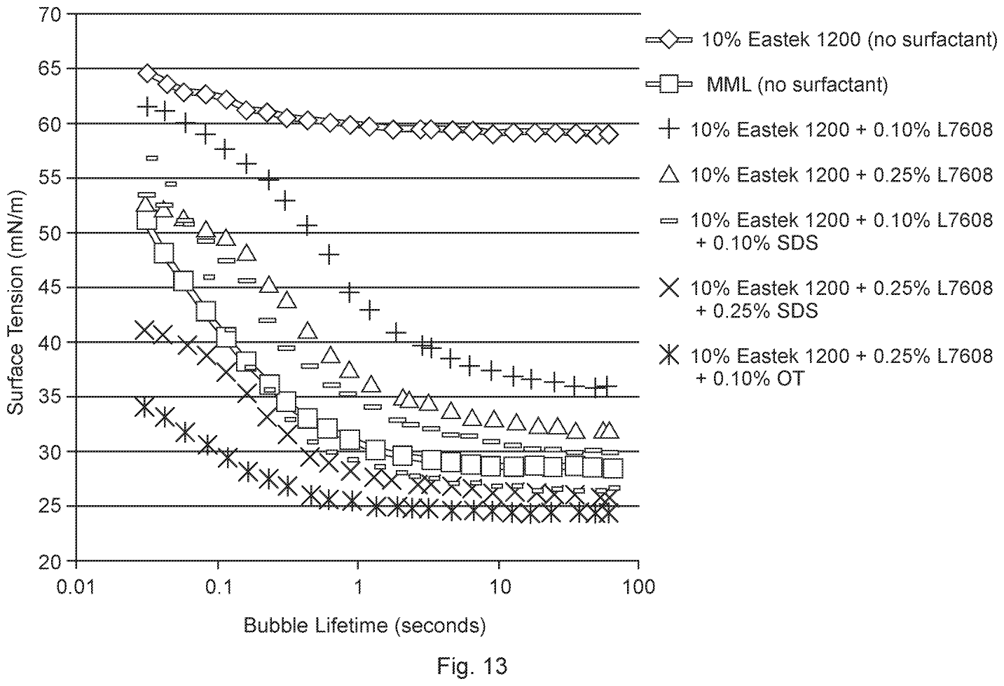

FIG. 13 illustrates the surface tension curves for 10% by weight of EASTEK™ 1200 and water (no surfactants); 10% by weight of EASTEK™ 1200 and one or more of SILWET® L-7608 (0.1 wt %. 0.25 wt % or 0.5 wt %), a polyalkyleneoxide modified heptamethyltrisiloxane surfactant available from Momentive Performance Materials and/or SDS (0.1 wt % or 0.25 wt %) and/or DOSS (OT) (0.25 wt %) and/or AEROSOL™ MA80L (0.25 wt %); and MML (one example of a core liquid).

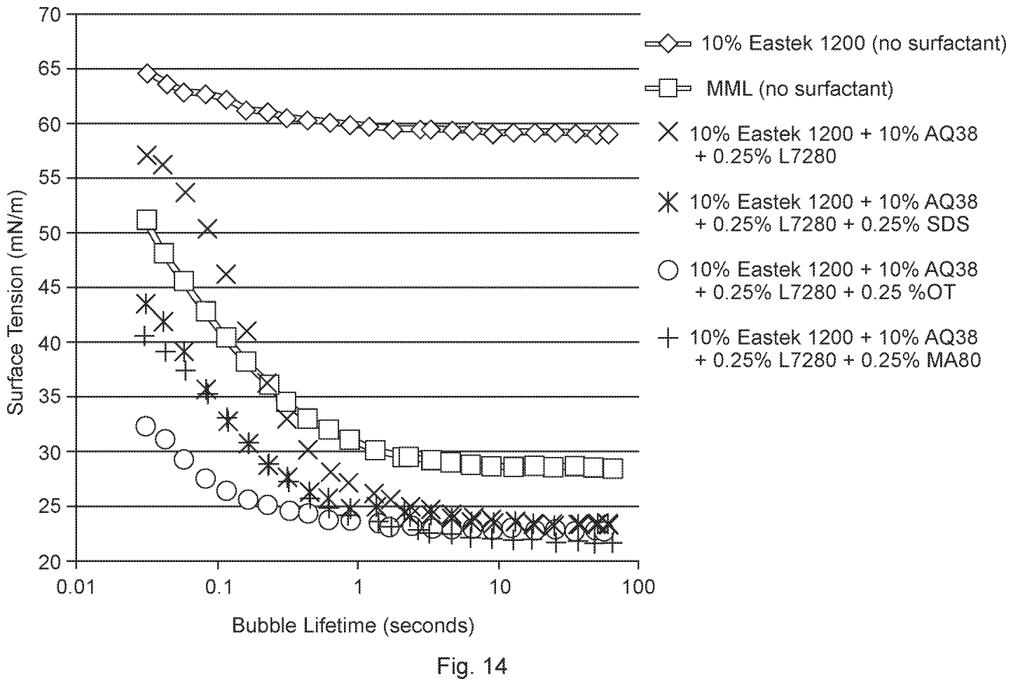

FIG. 14 illustrates the surface tension curves for 10% by weight of EASTEK™ 1200 and water (no surfactants); 10% by weight of Eastman AQ™38 S and one or more of SILWET® L-7280 (0.25 wt %), a polyalkyleneoxide modified heptamethyltrisiloxane surfactant available from Momentive Performance Materials and/or SDS (0.25 wt %) and/or DOSS (0.25 wt %) and/or AEROSOL™ MA80 (0.25 wt %); and MML (one example of a core liquid).

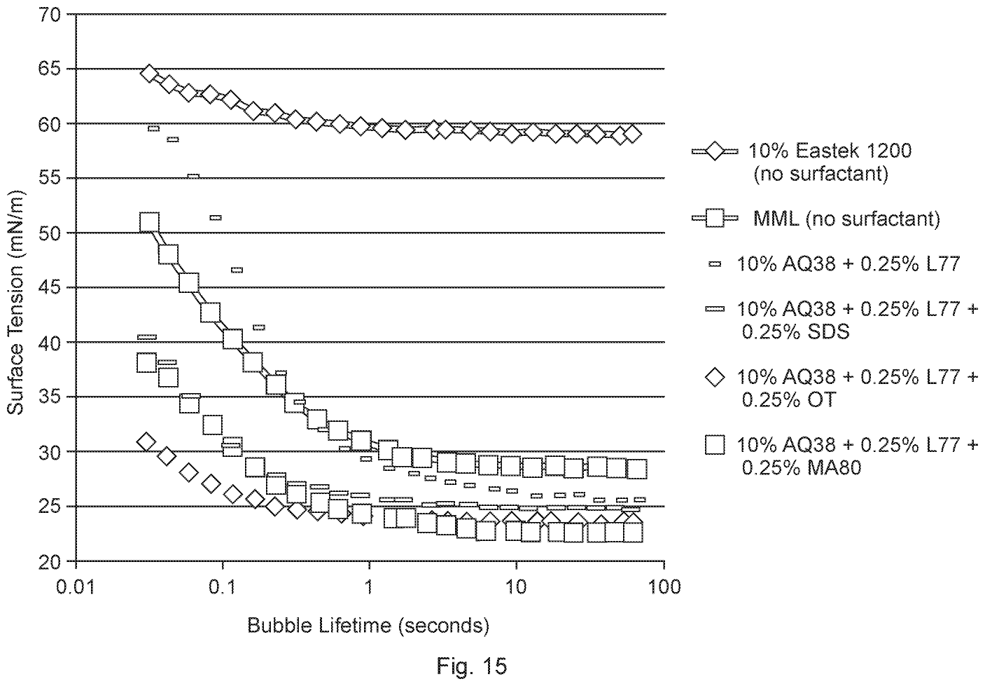

FIG. 15 illustrates the surface tension curves for 10% by weight of EASTEK and water (no surfactants); 10% by weight of Eastman AQ38S and one or more of SILWET® L-77 (0.25 wt %), a polyalkyleneoxide modified heptamethyltrisiloxane surfactant available from Momentive Performance Materials and/or SDS (0.25 wt %) and/or DOSS (OT) (0.25 wt %) and/or AEROSOL™ MA80 (0.25 wt %); and MML (one example of a core liquid).

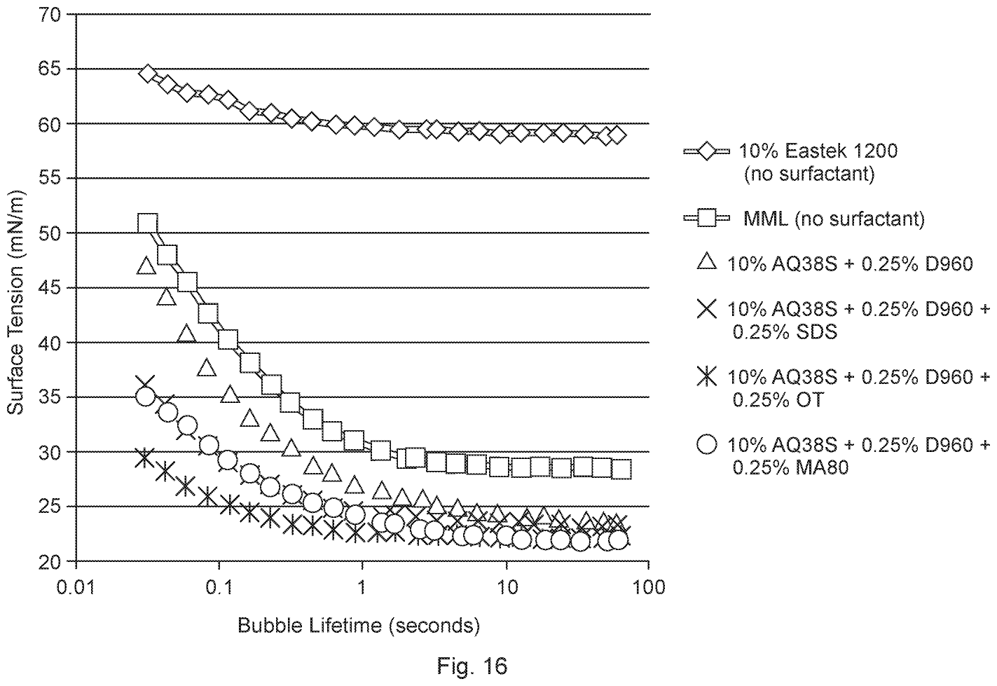

FIG. 16 illustrates the surface tension curves for 10% by weight of EASTEK™ and water (no surfactants); 10% by weight of Eastman AQ™38 S and one or more of DYNOL™ 960 (0.25 wt %) and/or SDS (0.25 wt %) and/or DOSS (0.25 wt %) and/or AEROSOL™ MA80 (0.25 wt %); and MML (one example of a core liquid).

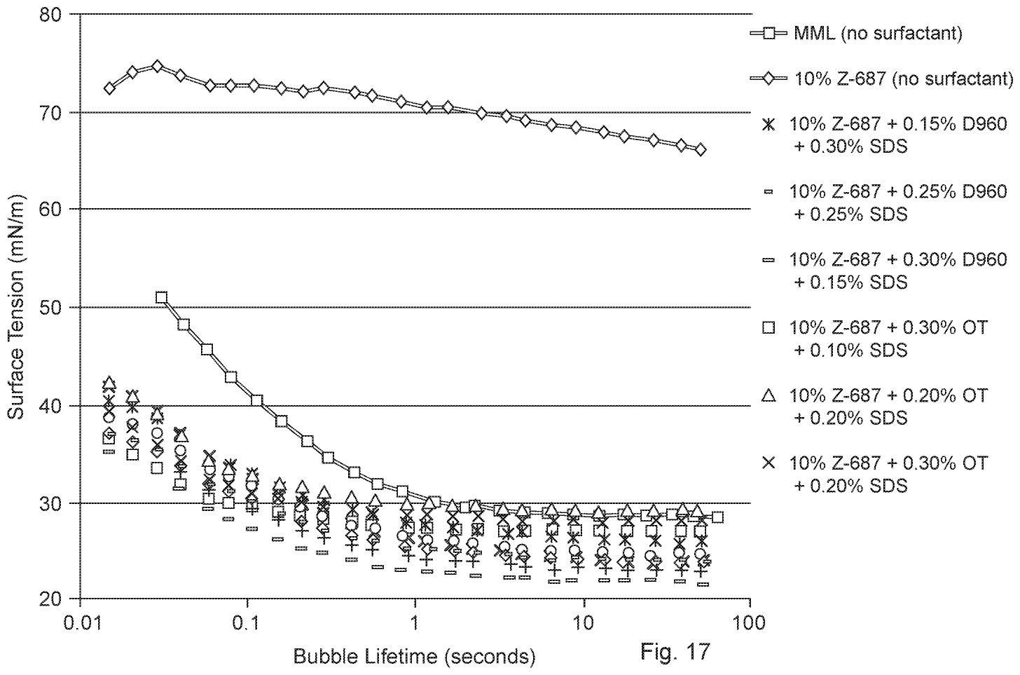

FIG. 17 illustrates the surface tension curves for 10 wt % PLASCOAT™ Z-687, an aqueous polyester co-polymer available from Goo Chemical Co., Ltd., Japan; and/or DYNOL™ 960 (0.15 wt %, 0.25 wt %, 0.30 wt %); and/or SDS (0.10 wt %, 0.15 wt %, 0.25 wt %, 0.30 wt %); and/or DOSS (OT) (0.2 wt %, 0.3 wt %); and MML (one example of a core liquid).

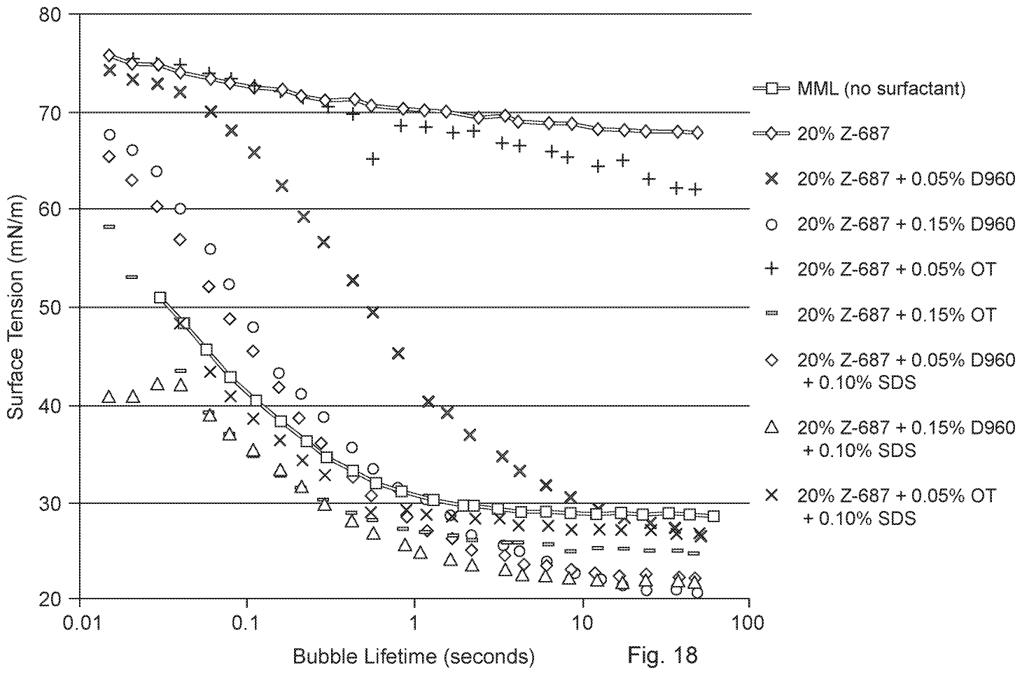

FIG. 18 illustrates the surface tension curves for 20 wt % PLASCOAT™ Z-687; and/or DYNOL™ 960 (0.05 wt %, 0.15 wt %); and/or SDS (0.1 wt %); and/or DOSS (0.05 wt %, 0.15 wt %) and MML (one example of a core liquid)

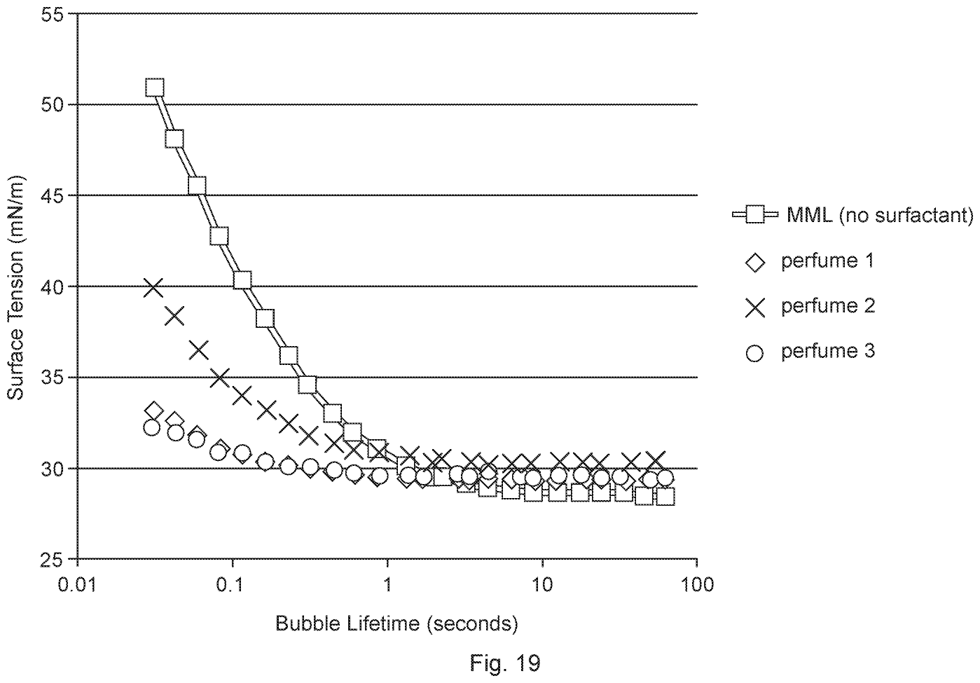

FIG. 19 illustrates the surface tension curves for several non-limiting examples of core liquids, including a perfume oil #1; a perfume oil #2; a perfume oil #3; and MML.

FIG. 20 illustrates the interfacial tension curves for the following illustrative combinations of shell liquids and core liquids: 1) Shell Liquid—10 wt % Eastman AQ™38 S and balance water and Core Liquid—50 wt % MML and 50 wt % IPM; 2) Shell Liquid—10 wt % Eastman AQ™ 38 S and balance water and Core Liquid—MML; and 3) Shell Liquid—10 wt % Eastman AQ™ 38 S, 0.5% by weight DYNOL™ 960, 0.5% SDS, and balance water and Core Liquid 99 wt % MML and 1 wt % sodium dioctyl sulfosuccinate or DOSS (available from Cytec Industries, Inc. under the name AEROSOL™ OT). The combination of MML and IPM illustrate that it is possible to raise, rather than lower, the dynamic interfacial tension of the core liquid by the choice of additives included with the one or more oils of the core liquid.

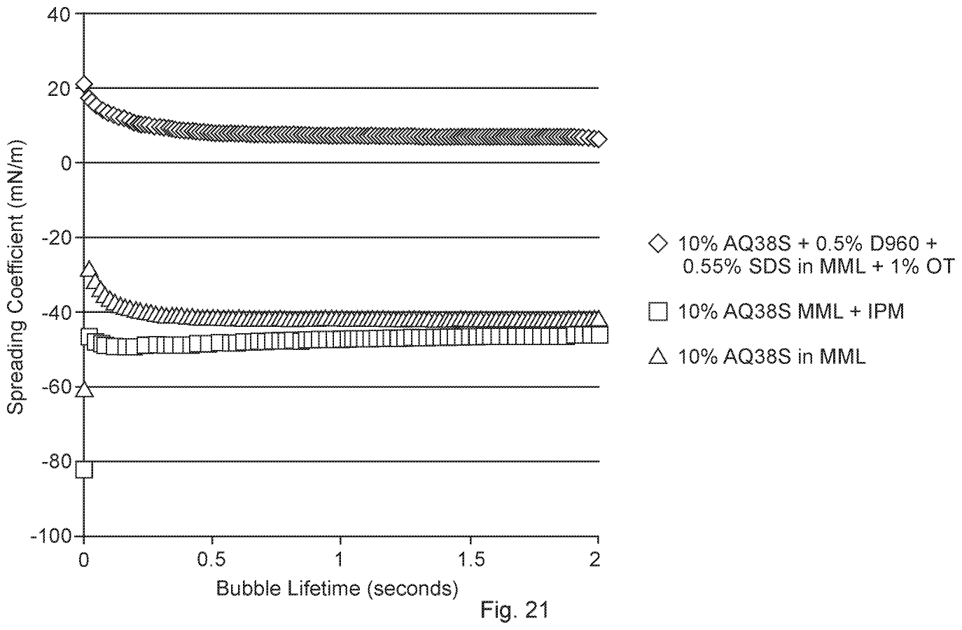

As an example, it is possible to calculate spreading coefficients from the surface tensions and interfacial tensions shown in FIGS. 5 and 20 using the spreading coefficient equation set forth previously. FIG. 21 illustrates spreading coefficient curves to time T=2 seconds for the following combinations of shell liquids and core liquids: 1) Shell Liquid=10 wt % Eastman AQ™38 S and balance water and Core Liquid=50 wt % MML and 50 wt % IPM; 2) Shell Liquid=10 wt % Eastman AQ™38 S and balance water and Core Liquid=100 wt % MML; and 3) Shell Liquid=10 wt % Eastman AQ38™ S, 0.5 wt % DYNOL™ 960, 0.55 wt % SDS, and balance water and Core Liquid=99 wt % MML and 1 wt % DOSS (OT).

b. Surfactants

A variety of surfactants may be incorporated into the shell liquid and/or core liquid to achieve the desired dynamic spreading coefficient within the ranges described herein. As discussed above, the shell liquid and/or the core liquid may comprise one or more surfactants. The shell liquid and/or the core liquid may include one or more surfactants selected from anionic surfactants, amphoteric surfactants, cationic surfactants, non-ionic surfactants, zwitterionic surfactants, and mixtures thereof.

Anionic Surfactants

In some instances, the anionic surfactants may be present in acid form or in neutralized (e.g., salt) form. In some instances, the anionic surfactants may be linear, branched, or a mixture thereof. Non-limiting examples of anionic surfactants are the alkali metal salts of C10-C18 alkyl sulfonic acids, such as sodium dodecyl sulfate, and the alkali metal salts of C10-C18 alkyl benzene sulfonic acids, the C11-C14 alkyl benzene sulfonic acids or dialkyl sulfosuccinates, such as dioctyl sulfosuccinate.

In some aspects, the alkyl group is linear, and such linear alkyl benzene sulfonates are known as “LAS.” Alkyl benzene sulfonates, and particularly LAS, are well known in the art. Such surfactants and their preparation are described in, for example, U.S. Pat. Nos. 2,220,099 and 2,477,383.

Amphoteric Surfactants

Non-limiting examples of amphoteric surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. Examples of compounds falling within this definition are sodium 3-(dodecylamino)propionate, sodium 3-(dodecylamino) propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine. Illustrative amphoteric surfactants are shown and described in U.S. Pat. No. 3,929,678 at column 19, lines 18-35.

Cationic Surfactants

Non-limiting cationic surfactants include quaternary ammonium surfactants, which can have up to about 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) trimethyl quaternary ammonium such as lauryl trimethyl quaternary ammonium d) polyamine cationic surfactants as discussed in WO 98/35002, WO 98/35003, WO 98/35004, WO 98/35005, and WO 98/35006; e) cationic ester surfactants as discussed in U.S. Pat. Nos. 4,228,042, 4,239,660 4,260,529 and 6,022,844; and e) amino surfactants as discussed in U.S. Pat. No. 6,221,825 and WO 00/47708, specifically amido propyldimethyl amine (APA).

Non-Ionic Surfactants

Non-limiting examples of nonionic surfactants include: a) C12-C18 alkyl ethoxylates, such as, NEODOL® nonionic surfactants from Shell; b) C6-C12 alkyl phenol alkoxylates where the alkoxylate units are a mixture of ethyleneoxy and propyleneoxy units; c) C12-C18 alcohol and C6-C12 alkyl phenol condensates with ethylene oxide/propylene oxide block polymers such as PLURONIC® from BASF; d) Alkylpolysaccharides as discussed in U.S. Pat. No. 4,565,647; specifically alkylpolyglycosides as discussed in U.S. Pat. Nos. 4,483,780 and 4,483,779; e) Polyhydroxy fatty acid amides as discussed in U.S. Pat. No. 5,332,528, WO 92/06162, WO 93/19146, WO 93/19038, and WO 94/09099; and f) ether capped poly(oxyalkylated) alcohol surfactants as discussed in U.S. Pat. No. 6,482,994 and WO 01/42408.

Zwitterionic Surfactants

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Illustrative zwitterionic surfactants are disclosed in U.S. Pat. No. 3,929,678 at column 19, line 38 through column 22, line 48 such as, for example, betaines, including alkyl dimethyl betaine and cocodimethyl amidopropyl betaine, C8 to C18 (for example from C12 to C18) amine oxides and sulfo and hydroxy betaines, such as N-alkyl-N,N-dimethylammino-1-propane sulfonate where the alkyl group can be C8 to C18 and in certain embodiments from C10 to C14.

The one or more surfactants may also include any of the surfactants or combinations thereof shown and described in the following: Handbook of Surfactants, 1991, M. R. Porter, published by Springer Science+Business Media, LLC, M. R. Porter, 1991, U.S. Pat. Publ. Nos.: 2014/0349908, 2015/093347, and 2015/182993, EP0006655, and/or EP0320219, which are all hereby incorporated by reference herein.

The shell liquid may comprise one or more surfactants that reduce the dynamic surface tension of the shell liquid by greater than 25%, 30%, 40% or 50% or more, preferably from T=0.03 or 0.1 seconds to T=1, 0.75, 0.5 or 0.25 seconds compared to the shell liquid without the surfactant(s) (i.e., the surfactants being replaced by water).

As one example, FIG. 5 illustrates a reduction in surface tension between 10 wt % Eastman AQ™38 S (balance water) and 10 wt % AQ™38 S in combination with 0.5 wt % DYNOL™ 960 and 0.5 wt % SDS (balance water). The shell liquid and/or the core liquid may further comprise one or more surfactants that lower the dynamic interfacial tension between the core liquid and the shell liquid by greater than 25%, 30%, 40% or 50% at T=0.03 or 0.1 seconds to T=1, 0.75, 0.5 or 0.03 seconds compared to the shell liquid (and core liquid) without the surfactants. As an example, FIG. 20 illustrates a reduction in interfacial tension between a shell liquid comprising 10 wt % Eastman AQ™38 S (balance water) with a core liquid comprising 100 wt % MML on the one hand and a shell liquid comprising 10 wt % Eastman AQ38S with 0.5 wt % DYNOL™ 960 and 0.55 wt % SDS (balance water) and a core liquid comprising 99 wt % MML with 1 wt % DOSS (OT) on the other hand. FIG. 20 further illustrates that adding the wrong materials, such as IPM in some instances, may actually increase the interfacial tensions as can be seen by comparing the interfacial tensions for a shell liquid comprising 10 wt % Eastman AQ™38 S (balance water) with a core liquid comprising 100 wt % MML on the one hand and a shell liquid comprising 10 wt % Eastman AQ™38 S (balance water) with a core liquid comprising 50 wt % MML and 50 wt % IPM on the other hand. FIG. 5 also illustrates that adding the wrong materials to the core liquid, such IPM in some instances, may actually decrease the surface tension of the core liquid thereby making it more difficult to achieve a positive dynamic spreading coefficient.

In some instances, the shell liquid comprises one or more surfactants comprising a siloxane functional group having the following formula:

Si—O—Si

Some preferred siloxane containing surfactants are available: i) under the brand name DYNOL™ Superwetting Surfactants (Air Products and Chemicals, Inc.), ii) under the brand name SILWET® (Momentive Performance Materials), and iii) from BYK USA, Inc. under the BYK brand name. It is believed one or more of these surfactants may be particularly useful for lowering dynamic surface tensions of a shell liquid. In some instances, this shell liquid comprises a polyester wall forming material. In some instances, one or more surfactants comprising a siloxane functional group are included at a concentration less than 1% or less than 0.75% by weight of the shell liquid. In some instances, one or more surfactants containing a siloxane functional group have a concentration from about 0.1 wt % to 0.5 wt % of the shell liquid.

In some instances, the shell liquid and/or the core liquid may comprise two or more surfactants to achieve the desired dynamic surface tension and/or dynamic interfacial tensions to yield a dynamic spreading coefficient greater than zero, preferably from T=0.03 or 0.1 seconds and/or to T=1, 0.75, 0.5 or 0.25 seconds. Some preferred surfactant combinations, include, but are not limited to: i) a surfactant having a siloxane functional group and an anionic surfactant, ii) a surfactant having a siloxane functional group and a sulfosuccinate surfactant (e.g., having both carboxylate and sulfonate groups), and iii) a first surfactant having a siloxane functional group and a second surfactant having a siloxane functional group. In some instances, the shell liquid comprises 2 or more surfactants selected from the group consisting of a surfactant having a siloxane functional group, a second surfactant having a siloxane functional group, a sulfosuccinate surfactant, an anionic surfactant and mixtures thereof. In some instances, the core liquid may comprise a sulfosuccinate surfactant.

c. Core Liquids

The core liquid may be stored in a tank or reservoir and pumped to a liquid droplet forming device, although it is also envisioned that a plurality of liquids may be stored in a plurality of tanks and the liquids are pumped to the liquid droplet forming device and mixed in the device to form the core liquid.

The core liquid comprises one or more oils and one or more surfactants. In some instances, the core liquid comprises greater than 50%, 60%, 70%, 80%, 90%, 95% or 99% by weight of the one or more oils. In some instances, the core liquid consists essentially of or consists of the one or more oils. The one or more oils may also be a benefit agent, such as in the case of perfume oils or sensates (e.g., warming sensates, tingling sensates, or cooling sensates). The one or more oils may also be a carrier for one or more benefit agents that are soluble or dispersible in the oil(s). Optionally, the core liquid may comprise one or more other materials that are benefit agents. In some instances, the one or more oils are organic oils. Some non-limiting examples of oils include mineral oil and/or petrolatum (when melted), essential oils, vegetable oils, perfume oils and mixtures thereof.

Essential oils are those oils derived from parts of plants, such as the bark, berries, flowers, leaves, peel, resin, rhizome, root, seeds or wood thereof. Some non-limiting examples of essential oils, include, but are not limited to agar oil, ajwain oil, Angelica root oil, anise oil, asafoetida, balsam, basil oil, bay oil, bergamot oil, black pepper essential oil, buchu oil, birch, camphor, Cannabis flower essential oil, caraway oil, cardamom seed oil, carrot seed oil, cedarwood oil, chamomile oil, calamus root, cinnamon oil, cistus, citron, citronella oil, clary sage, clove oil, coffee, coriander, costmary oil, costus root, cranberry seed oil, cubeb, cumin oil/black seed oil, cypress, cypriol, curry leaf, davana oil, dill oil, elecampane, Eucalyptus oil, fennel seed oil, fenugreek oil, fir, frankincense oil, galangal, Galbanum, Geranium oil, ginger oil, goldenrod, grapefruit oil, henna oil, Helichrysum, hickory nut oil, horseradish oil, hyssop, idaho tansy, jasmine oil, juniper berry oil, Laurus nobilis, lavender oil, ledum, lemon oil, lemongrass, lime, Litsea cubeba oil, linaloe, mandarin, marjoram, Melaleuca or tea tree oil, melissa oil (lemon balm), Mentha arvensis oil/mint oil, Moringa oil, mountain savory, mugwort oil, mustard oil, myrrh oil, myrtle, neem oil or neem tree oil, neroli, nutmeg, orange oil, oregano oil, orris oil, palo santo, parsley oil, patchouli oil, Perilla essential oil, peppermint oil, petitgrain, pine oil, ravensara, red cedar, roman chamomile, rose oil, rosehip oil, rosemary oil, rosewood oil, sage oil, sandalwood oil, Sassafras oil, savory oil from Satureja species, schisandra oil, spearmint oil, spikenard, spruce oil, star anise oil, tangerine, tarragon oil, tea tree oil, thyme oil, Tsuga, turmeric, valerian, vetiver oil (khus oil), western red cedar, wintergreen, yarrow oil, ylang-ylang, and zedoary.

A vegetable oil comprises a triglyceride extracted from a plant material. Common vegetable oils include, but are not limited to, coconut oil, corn oil, cottonseed oil, olive oil, palm oil, peanut oil, rapeseed oil, safflower oil, sesame oil, soybean oil and sunflower oil. Nut oils include oils derived from at least one part of or known as the oil of: almond, beech nut, brazil nut, cashew, hazelnut, Macadamia, mongongo nut, pecan, pine nut, pistachio, and walnut. Citrus Oils include grapefruit seed oil, lemon oil and orange oil. Melon and gourd seed oils include: bitter gourd oil, bottle gourd oil, buffalo gourd oil, butternut squash seed oil, egusi seed oil, pumpkin seed oil, and watermelon seed oil. Some other oils include acai oil, black seed oil, blackcurrant seed oil, borage seed oil, evening primrose oil, and flaxseed oil (aka linseed oil) and oil derived from amaranth, apricot, apple seed, argan, avocado, babassu, ben, borneo tallow nut, cape chestnut, carob pod oil, chestnut, cocoa butter, cohune, coriander seed, date seed, dika, false flax, grape seed, hemp, kapok seed, kenaf seed, Lallemantia, mafura, marula, meadowfoam seed, mustard, Niger seed, nutmeg butter, okra seed, Papaya seed, Perilla seed, persimmon seed, pequi, pili nut, pomegranate seed, poppyseed, pracxi, prune kernel, Quinoa, ramtil, rice bran, royle, sacha inchi, sapote, seje, shea butter, taramira, tea seed, thistle, tigernut, tobacco seed, tomato seed, and wheat germ.

The term “perfume oil” refers to any perfume raw material, or mixture of perfume raw materials, that comprise oils and is/are intended to deliver a fragrance experience to a consumer, inclusive of carriers, solvents, etc., that are customarily provided with the perfume raw material by a supplier thereof. A wide variety of perfume oils may be incorporated in the core liquid. In some instances the perfume oil may comprise a material selected from the group consisting of prop-2-enyl 3-cyclohexylpropanoate, (4aR,5R,7aS,9R)-octahydro-2,2,5,8,8,9a-hexamethyl-4h-4a,9-methanoazuleno(5,6-d)-1,3-dioxole, (3aR,5aS,9aS,9bR)-3a,6,6,9a-tetramethyl-2,4,5,5a,7,8,9,9b-octahydro-1H-benzo[e][1]benzofuran, 4-methoxybenzaldehyde, benzyl 2-hydroxybenzoate, 2-methoxynaphthalene, 3-(4-tert-butylphenyl)propanal, 3a,6,6,9a-tetramethyl-2,4,5,5a,7,8,9,9b-octahydro-1H-benzo[e][1]benzofuran, 3,7-dimethyloct-6-en-1-ol, 3,7-dimethyloct-6-enenitrile, 3-(4-tert-butylphenyl)butanal, 3-(4-propan-2-ylphenyl)butanal, (E)-1-(2,6,6-trimethyl-1-cyclohexa-1,3-dienyl)but-2-en-1-one, decanal, (E)-1-(2,6,6-trimethyl-1-cyclohex-3-enyl)but-2-en-1-one, (5E)-3-methylcyclopentadec-5-en-1-one, 2,6-dimethyloct-7-en-2-ol, ethyl 2-methylpentanoate, ethyl 2-methylbutanoate, 1,3,3-trimethyl-2-oxabicyclo[2,2,2]octane, 2-methoxy-4-prop-2-enylphenol, 3a,4,5,6,7,7a-hexahydro-4,7-methano-1H-indenyl acetate, 3-(3-propan-2-ylphenyl)butanal, a,4,5,6,7,7a-hexahydro-1H-4,7-methanoinden-1-yl propanoate, (2E)-3,7-dimethylocta-2,6-dien-1-ol, (12E)-1-oxacyclohexadec-12-en-2-one, [2-[1-(3,3-dimethylcyclohexyl)ethoxy]-2-methylpropyl]propanoate, hexyl acetate, 2-(phenylmethylidene)octanal, hexyl 2-hydroxybenzoate, (E)-4-(2,6,6-trimethyl-1-cyclohex-2-enyl)but-3-en-2-one, (E)-4-(2,6,6-trimethyl-1-cyclohexenyl)but-3-en-2-one, (E)-3-methyl-4-(2,6,6-trimethyl-1-cyclohex-2-enyl)but-3-en-2-one, 1-(2,3,8,8-tetramethyl-1,3,4,5,6,7-hexahydronaphthalen-2-yl)ethanone, propan-2-yl 2-methylbutanoate, (1R,2S,5R)-5-methyl-2-propan-2-ylcyclohexan-1-ol, (E)-2-ethyl-4-(2,2,3-trimethyl-1-cyclopent-3-enyl)but-2-en-1-ol, 2,4-dimethylcyclohex-3-ene-1-carbaldehyde, 3,7-dimethylocta-1,6-dien-3-ol, 3,7-dimethylocta-1,6-dien-3-yl acetate, 1-((3R,3aS,7R,8aS)-2,3,4,7,8,8a-hexahydro-3,6,8,8-tetramethyl-1H-3a,7-methanoazulen-5-yl)-ethanone, methyl 3-oxo-2-pentylcyclopentaneacetate, 2-methylundecanal, 2-[2-(4-methyl-1-cyclohex-3-enyl)propyl]cyclopentan-1-one, 1-(5,5-dimethyl-1-cyclohexenyl)pent-4-en-1-one, 2-cyclohexylidene-2-phenylacetonitrile, 2-phenylethanol, 3,7-dimethyloctan-3-ol, 5-heptyloxolan-2-one, (2-tert-butylcyclohexyl) acetate, (E)-4-methyldec-3-en-5-ol, (4-tert-butylcyclohexyl) acetate, decahydro-2,2,6,6,7,8,8-heptamethyl-2H-indeno(4,5-b)furan, 17-oxacycloheptadec-6-en-1-one, pentyl 2-hydroxybenzoate, benzyl acetate, 4-phenylbutan-2-one, 2-methoxynaphthalene, 1,7,7-trimethylbicyclo[2,2,1]heptan-2-one, 1,1,2,3,3-pentamethyl-2,5,6,7-tetrahydro-inden-4-one, 1H-3a,7-Methanoazulene, octahydro-6-methoxy-3,6,8,8-tetramethyl, [(Z)-hex-3-enyl] acetate, [(Z)-hex-3-enyl] 2-hydroxybenzoate, (9Z)-cycloheptadec-9-en-1-one, chromen-2-one, cyclohexyl 2-hydroxybenzoate, ethyl 3-methyl-3-phenyloxirane-2-carboxylate, 3-ethoxy-4-hydroxybenzaldehyde, 1,4-dioxacycloheptadecane-5,17-dione, 16-oxacyclohexadecan-1-one, diethyl cyclohexane-1,4-dicarboxylate, 1-(5,5-dimethyl-1-cyclohexenyl)pent-4-en-1-one, [(2E)-3,7-dimethylocta-2,6-dienyl] acetate, 3-(1,3-benzodioxol-5-yl)-2-methylpropanal, 1,3-benzodioxole-5-carbaldehyde, 6-(pent-3-en-1-yl)tetrahydro-2H-pyran-2-one, [(1R,2S)-1-methyl-2-[[(1R,3S,5S)-1,2,2-trimethyl-3-bicyclo[3.1.0]hexanyl]methyl]cyclopropyl]methanol, (Z)-3,4,5,6,6-pentamethyl-hept-3-en-2-one, dodecanal, 3,7-dimethylnona-2,6-dienenitrile, (2S)-2-aminopentanedioic acid, methyl 2,4-dihydroxy-3,6-dimethylbenzoate, 2,6-dimethyloct-7-en-2-ol, 4-(4-hydroxy-4-methylpentyl)cyclohex-3-ene-1-carbaldehyde, 1-naphthalen-2-ylethanone, 4-methyl-2-(2-methylprop-1-enyl)oxane, 1H-Indene-ar-propanal, 2,3-dihydro-1,1-dimethyl-(9CI), nonanal, octanal, 2-phenylethyl 2-phenylacetate, 3-methyl-5-phenylpentan-1-ol, 4-methyl-2-(2-methylpropyl)oxan-4-ol, 1-oxacycloheptadecan-2-one, 1-(spiro[4,5]dec-7-en-7-yl)pent-4-en-1-one, 2-(4-methyl-1-cyclohex-3-enyl)propan-2-ol, 1-methyl-4-propan-2-ylidenecyclohexene, (4-methyl-1-propan-2-yl-1-cyclohex-2-enyl) acetate, 1,2-dimethylcyclohex-3-ene-1-carbaldehyde, undec-10-enal, [(4Z)-1-cyclooct-4-enyl] methyl carbonate, 8-methyl-1,5-benzodioxepin-3-one, nona-2,6-dienal, (SZ)-cyclohexadec-5-en-1-one, 2,6,10-trimethylundec-9-enal, prop-2-enyl hexanoate, (E)-1-(2,6,6-trimethyl-1-cyclohex-2-enyl)but-2-en-1-one, 3-phenylprop-2-en-1-ol, 3,7-dimcthylocta-2,6-dienal, 3,7-dimethyloct-6-enyl acetate, [2-(2-methylbutan-2-yl)cyclohexyl] acetate, 3a,4,5,6,7,7a-hexahydro-4,7-methano-1H-inden-5-yl 2-methyl propanoate, 2-pentylcyclopentan-1-ol, (E)-dec-4-enal, 2-pentylcyclopentan-1-one, 2-methoxy-4-propylphenol, methyl 2-hexyl-3-oxocyclopentane-1-carboxylate, phenoxybenzene, ethyl 3-phenylprop-2-enoate, (E)-2-ethyl-4-(2,2,3-trimethyl-1-cyclopent-3-enyl)but-2-en-1-ol, 3-(4-ethylphenyl)-2,2-dimethyl-propanal, 4-methyl-2-(2-methylpropyl)oxan-4-ol, 2-methyldecanenitrile, 5-hexyloxolan-2-one, 5-(diethoxymethyl)-1,3-benzodioxolc, 7-hydroxy-3,7-dimethyloctanal, (E)-4-(2,5,6,6-tetramethyl-1-cyclohex-2-enyl)but-3-en-2-one, [(1R,4S,6R)-1,7,7-trimethyl-6-bicyclo[2.2.1]heptanyl] acetate, 6-butan-2-ylquinoline, 2-methoxy-4-prop-1-en-2-ylphenol, (NE)-N-[(6E)-2,4,4,7-tetramcthylnona-6,8-dien-3-ylidene]hydroxylamine, (4-propan-2-ylcyclohexyl)-methanol, 2,6-dimethylhept-5-enal, (1R,2S,5R)-5-methyl-2-propan-2-ylcyclohexan-1-ol, ethyl 2-(2-methyl-1,3-dioxolan-2-yl)acetate, 1-phenylethyl acetate, 1-(3,5,5,6,8,8-hexamethyl-6,7-dihydronaphthalen-2-yl)ethanone, 6-butyloxan-2-one, 2,4-dimethyl-2-(5,6,7,8-tetrahydro-5,5,8,8-tetramethyl-2-naphthalenyl)-1,3-dioxolane, (2R,4S)-2-methyl-4-propyl-1,3-oxathianc, 4-(4-hydroxyphenyl)butan-2-one, 3-methyl-5-phenylpentan-1-ol, 4-((1R,5S)-6,6-dimethylbicyclo[3.1.1]hept-2-en-2-yl)-3,3-dimethylbutan-2-one, 3-methylbut-2-enyl acetate, dec-9-en-1-ol, 5-(3-methylphenyl)pentan-1-ol, 3,7-dimethyloctan-3-ol, 1-methoxy-4-[(E)-prop-1-enyl]benzene, 4-hydroxy-3-methoxybenzaldehyde, 9-acetyl-2,6,6,8-tetramethyltricyclo(5.3.1.01,5)undec-8-ene, 2,5-dioxacyclohexa-decane-1,6-dione and mixtures thereof.

e. Shell Liquids

The shell liquid may be stored in a tank or reservoir and pumped to a liquid droplet forming device, although it is envisioned that a plurality of liquids may be stored in a plurality of tanks which are pumped to the liquid droplet forming device and mixed in the device to form the shell liquid.

The shell liquid comprises water, one or more surfactants, and a wall forming material. In some instances, the shell liquid comprises greater than 60%, 70%, 80% or 85% of water by weight of the shell liquid. While the shell liquid may comprise other carriers, it is preferred that the shell liquid comprises less than 20%, 10%, 5% or 3% by weight of the shell liquid of flammable liquids. Preferably, the shell liquid is substantially or completely free of flammable liquids, such as alcohols (e.g., ethanol), due to the explosive risks when used with a drying chamber.

The shell liquid comprises one or more wall forming materials that form a solid shell upon evaporation of the water in the shell liquid. Some examples include water soluble or water dispersible organic materials, typically oligomers or polymers that form a film or are otherwise capable of forming a solid shell upon evaporation of the water. The wall forming material may have a concentration in the shell liquid of greater than 5%, 10%, 15% and/or less than 40% or 30% or 20% by weight of the shell liquid. In some instances, it may be desirable for the concentration of the one or more wall forming materials be less than 20 wt % so that the viscosity of the shell liquid is less than 200 cP, 150 cP, or 100 cP and is flowable through the small passages of microfluidic devices.

Some non-limiting examples of wall forming materials include synthetic polymeric materials or natural polymers. Synthetic polymers can be derived from petroleum oil, for example. Some non-limiting examples of synthetic polymers include polyesters, polyacrylates, and mixtures thereof. Some non-limiting examples of natural polymers are polysaccharides.

In some instances, the wall forming material may be selected from the group consisting of shellacs, polyesters and mixtures thereof, which are believed particularly suited use in consumer goods compositions comprising one or more surfactants having a concentration greater than 5%, 10%, or 15% by weight of the consumer goods composition for purposes of stability.

Polyvinyl alcohol, may act as both a surfactant/emulsifier and a wall forming material. Polyvinyl alcohol is also a water absorbing polymer, which is believed to hinder evaporation of water from the shell liquid in a drying chamber. As such, it is believed that the concentration of water absorbing polymers in the shell liquid is preferably less than 5%, 4%, 3%, 2% or 1% by weight of the shell liquid. This may reduce or eliminate the need to include an alcohol in the shell liquid as a water evaporative aid. Preferably, the shell liquid comprises a primary wall forming material (e.g., a wall forming material having the highest wt % of the shell liquid relative to any other wall forming material in the shell liquid) that is a water soluble or water dispersible oligomer or polymer having a DVS water sorption less than 5%, or less than 4%, or less than 3% or less than 2% or less than 1%.

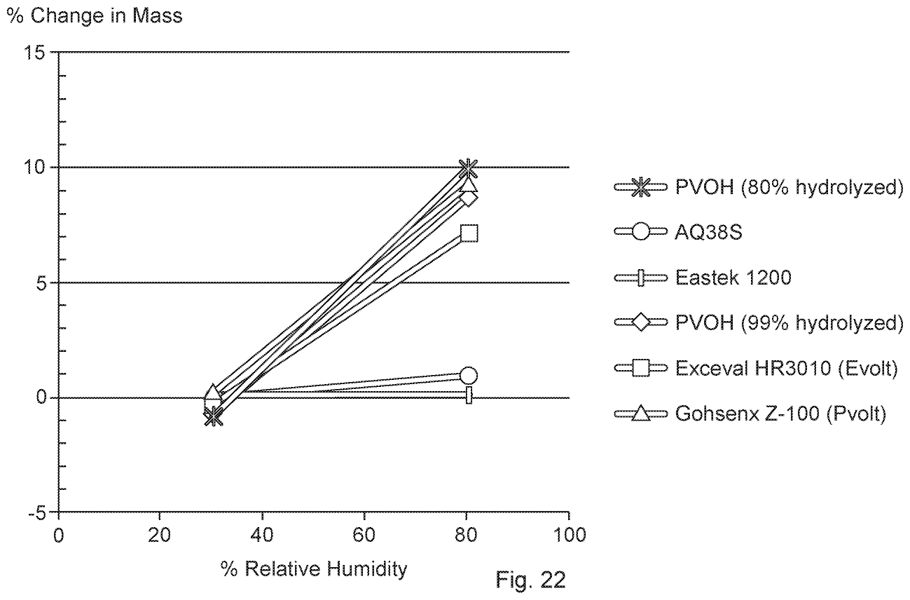

FIG. 22 illustrates DVS sorption isotherms (% change in mass of a material sample v. relative humidity at a constant 30° C.) for a 80% hydrolyzed polyvinyl alcohol (otherwise known as PVOH or PVA) available from Sigma Aldrich Co. as product code #360627, Eastman AQ38S, EASTEK™ 1200, a 99% hydrolyzed polyvinyl alcohol available from Sigma Aldrich Co. as product code # P1763, an ethylene vinyl alcohol co-polymer (EVOH) available from Kuraray Asia Pacific Pte. Ltd. under the Exceval HR3010, another polyvinyl alcohol available from Nippon Gohsei Co., Ltd. under the name Gohsefimer Z-100. Other than the AQ38S and EASTEK™ 1200, each of the aforementioned materials are considered water absorbing polymers herein.

A population of the microcapsules may be produced by the materials, compositions, devices, and systems described herein. The population of microcapsules may be collected at an exit of the drying chamber or downstream of the exit. In some instances, the population of microcapsules may have a mean equivalent diameter from 0.5 μm, or 1 μm, 5 μm or 10 μm to about 150 μm, or 100 μm, or 75 μm or 50 μm. A population of microcapsules may have a mean equivalent diameter coefficient of variation from 1% to 35%, preferably from 1% to 25%, more preferably from 1% to 10%. In some instances, this population of microcapsules may be produced from microfluidic device, which uses small dimensions to facilitate the production of small microcapsule sizes and more uniform microcapsule diameters.

### III. Compositions and Articles of Manufacture

In some instances, a population of microcapsules made according to the teachings herein may be incorporated in a composition or deposited upon or incorporated into an article of manufacture (e.g., a substrate, non-woven, etc.). The composition may be a consumer goods composition, such as a hair care composition (e.g., a shampoo or conditioner), a personal cleansing composition (e.g., a body wash), a fabric care composition or dish care composition. These compositions typically include a surfactant and one or more of an emulsifier, a chelating agent, a conditioning agent, a carrier and/or various other optional ingredients. Polyester and shellac wall forming materials are believed to be particularly well suited for use in these types of compositions for stability. Some non-limiting examples of various compositions are described in Publication Nos.: US2014/0179586; US2015/0267155; US2015/0267156; US2012/0297551; US2015/0376552; US2014/0026331; US2013/0061402; U.S. Pat. No. 8,729,007; and WO 2014/18309.

a. Composition Surfactants

In some instances, the composition may comprise one or more surfactants, including but not limited to an anionic surfactant, amphoteric or zwitterionic surfactants, or mixtures thereof. Various examples and descriptions of detersive surfactants are set forth in U.S. Pat. No. 6,649,155; U.S. Patent Application Publication No. 2008/0317698; and U.S. Patent Application Publication No. 2008/0206355, which are incorporated herein by reference in their entirety

Some examples of anionic surfactants include alkyl and alkyl ether sulfates. Other suitable anionic surfactants include water-soluble salts of organic, sulfuric acid reaction products. Still other suitable anionic surfactants include the reaction products of fatty acids esterified with isethionic acid and neutralized with sodium hydroxide. Other similar anionic surfactants are described in U.S. Pat. Nos. 2,486,921; 2,486,922; and 2,396,278, which are incorporated herein by reference in their entirety. Some exemplary anionic surfactants include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, sodium cocoyl isethionate and combinations thereof. In a further embodiment, the anionic surfactant is sodium lauryl sulfate or sodium laureth sulfate.

Some examples of amphoteric or zwitterionic surfactants include those which are known for use in shampoo or other personal care cleansing products. Concentrations of such amphoteric surfactants may range from about 0.5 wt % to about 20 wt %. Some non-limiting examples of suitable zwitterionic or amphoteric surfactants are described in U.S. Pat. Nos. 5,104,646 and 5,106,609, which are incorporated herein by reference in their entirety.

Some examples of amphoteric surfactants suitable include those surfactants broadly described as derivatives of aliphatic secondary and tertiary amines in which the aliphatic radical can be straight or branched chain and wherein one of the aliphatic substituents contains from about 8 to about 18 carbon atoms and one contains an anionic group such as carboxy, sulfonate, sulfate, phosphate, or phosphonate. Exemplary amphoteric detersive surfactants for use in a personal care composition include cocoamphoacetate, cocoamphodiacetate, lauroamphoacetate, lauroamphodiacetate, and mixtures thereof.

Some examples of zwitterionic surfactants include those surfactants broadly described as derivatives of aliphatic quaternaryammonium, phosphonium, and sulfonium compounds, in which the aliphatic radicals can be straight or branched chain, and wherein one of the aliphatic substituents contains from about 8 to about 18 carbon atoms and one contains an anionic group such as carboxy, sulfonate, sulfate, phosphate or phosphonate. In another embodiment, zwitterionics such as betaines are selected.

Some non-limiting examples of other anionic, zwitterionic, amphoteric or optional additional surfactants suitable for use in the personal care composition are described in McCutcheon's, Emulsifiers and Detergents, 1989 Annual, published by M. C. Publishing Co., and U.S. Pat. Nos. 3,929,678, 2,658,072; 2,438,091; 2,528,378, which are incorporated herein by reference in their entirety.

b. Conditioning Agents

In some instances, the composition may comprise a conditioning agent. Some examples include organic conditioning material and silicone conditioning agents. A silicone conditioning agent may comprise volatile silicone, non-volatile silicone, or combinations thereof. The concentration of the silicone conditioning agent may range from about 0.01% to about 10%, by weight of the composition. Some non-limiting examples of silicone conditioning agents, and optional suspending agents for the silicone, are described in U.S. Reissue Pat. No. 34,584, U.S. Pat. Nos. 5,104,646, and 5,106,609. Additional material on silicones including sections discussing silicone fluids, gums, and resins, as well as manufacture of silicones, are found in Encyclopedia of Polymer Science and Engineering, vol. 15, 2d ed., pp 204-308, John Wiley & Sons, Inc. (1989), incorporated herein by reference.

The conditioning agent may also comprise at least one organic conditioning material such as oil or wax, either alone or in combination with other conditioning agents, such as the silicones described above. The organic material can be non-polymeric, oligomeric or polymeric. It may be in the form of oil or wax and may be added in the formulation neat or in a pre-emulsified form. Some non-limiting examples of organic conditioning materials include, but are not limited to: i) hydrocarbon oils; ii) polyolefins, iii) fatty esters, iv) fluorinated conditioning compounds, v) fatty alcohols, vi) alkyl glucosides and alkyl glucoside derivatives; vii) quaternary ammonium compounds; viii) polyethylene glycols and polypropylene glycols having a molecular weight of up to about 2,000,000 including those with CTFA names PEG-200, PEG-400, PEG-600, PEG-1000, PEG-2M, PEG-7M, PEG-14M, PEG-45M and mixtures thereof.

c. Emulsifiers

In some instances, the composition may comprise an emulsifier. Anionic and nonionic emulsifiers can be either monomeric or polymeric in nature. Monomeric examples include, by way of illustrating and not limitation, alkyl ethoxylates, alkyl sulfates, soaps, and fatty esters and their derivatives. Polymeric examples include, by way of illustrating and not limitation, polyacrylates, polyethylene glycols, and block copolymers and their derivatives. Naturally occurring emulsifiers such as lanolins, lecithin and lignin and their derivatives are also non-limiting examples of useful emulsifiers.

d. Chelating Agents

In some instances, the composition may comprise a chelant. Suitable chelants include those listed in A E Martell & R M Smith, Critical Stability Constants, Vol. 1, Plenum Press, New York & London (1974) and A E Martell & R D Hancock, Metal Complexes in Aqueous Solution, Plenum Press, New York & London (1996) both incorporated herein by reference. When related to chelants, the term “salts and derivatives thereof” means the salts and derivatives comprising the same functional structure (e.g., same chemical backbone) as the chelant they are referring to and that have similar or better chelating properties. This term include alkali metal, alkaline earth, ammonium, substituted ammonium (i.e. monoethanolammonium, diethanolammonium, triethanolammonium) salts, esters of chelants having an acidic moiety and mixtures thereof, in particular all sodium, potassium or ammonium salts. The term “derivatives” also includes “chelating surfactant” compounds, such as those exemplified in U.S. Pat. No. 5,284,972, and large molecules comprising one or more chelating groups having the same functional structure as the parent chelants, such as polymeric EDDS (ethylenediaminedisuccinic acid) disclosed in U.S. Pat. No. 5,747,440.

e. Carriers

The compositions may be in the form of pourable liquids (under ambient conditions). Such compositions will therefore typically comprise a carrier, which is present at a level of from about 20 wt % to about 95 wt %, or even from about 60 wt % to about 85 wt %. The carrier may comprise water, or a miscible mixture of water and organic solvent, and in one aspect may comprise water with minimal or no significant concentrations of organic solvent, except as otherwise incidentally incorporated into the composition as minor ingredients of other essential or optional components.

f. Articles of Manufacture

In some instances, a population of microcapsules made using the teachings herein may be applied to and/or deposited onto one or more substrates. A substrate may comprise woven or non-woven materials, typically made from a plurality of fibers, films and similar materials. The population of microcapsules may be applied to the article of manufacture using any means known to one skilled in the art. In some instances, the microcapsules are embedded between fibers. A water insoluble adhesive composition may be used to bind the microcapsules to the substrate. As an alternative to embedding the microcapsules into the core of a substrate, the microcapsules may be coated on an outer surface of the substrate. Non-limiting examples of microcapsules deposited on substrates of personal care products are shown and described in the following: U.S. Publ. No. 2013/0239344, U.S. Publ. No. 2006/270586, U.S. Pat. Nos. 8,329,223, 6,774,063, 4,988,557, 4,186,743, 5,923,412. Non-limiting examples of such personal care products may include cleansing/cleaning wipes, paper towels, tissues, toilet paper, sanitary napkins, diapers, sponges, and other similar personal care products.

### IV. Test Methods

It is understood that the methods that are disclosed herein should be used to determine the respective values of the parameters of Applicants' invention as such invention is described and claimed herein. Furthermore, it is obvious to those skilled in the art that a population of rnicrocapsules may in some instances need to be isolated from an end product (e.g., skin care composition, hair care composition or fabric care composition) prior to using a method involving a microcapsule parameter (e.g., microcapsule equivalent diameter). These methods are well known in the art. The method of isolation will depend not only on the type and form of the product but also on the nature of the microcapsule. For example, microcapsules dispersed in a liquid product (e.g., a shampoo) might be isolated by centrifugation and re-dispersion in a non-solvent, while microcapsules in a solid product might be separated using a solvent for the binder and non-solvent for the microcapsules.

a. Interfacial Tension (IFT)/Dynamic Interfacial Tension (DIFT) Test Method

Interfacial tension (IFT) measurements between a pair of test liquids, such as the core liquid material and the shell liquid material, are obtained using the pendant drop method. Within this method the more hydrophilic liquid is dispensed as a hanging drop, and the more hydrophobic (oily) liquid is the bulk liquid into which the drop is hung. Suitable instrument systems for dispensing and imaging the pendant drop include equipment such as the Contact Angle Tensiometer model DCA-100, or General Drop Shape Instrument model FTA 1000 (both available from First Ten Angstroms Inc. (Portsmouth, Va., U.S.A.), or similar instruments. Such systems are equipped with a high performance digital video camera capable of capturing 50 frames/sec. Suitable cameras include the Prosilica GT model 1930 or 2000, (available from Allied Vision Technologies GmbH, Stadtroda, Germany). Interfacial Tension (IFT) values and the Drop Volumes are calculated from each captured image using the specialized video drop shape analysis software FTA32 Video Software Version 2.1 (available from First Ten Angstroms Inc., Portsmouth, Va., U.S.A.). For the purposes of this invention, the term “dynamic” is not to be inherently associated with the measured IFT values reported by the drop shape analysis software, regardless of how that terminology is used by the software or in common language. Rather, for IFT values the term “dynamic” is only to be associated with predicted IFT values that are output from the curve fitting and modelling procedures specified here, and which additionally meet the slope value criteria also specified herein.

Both liquids in the pairing to be tested are equilibrated to approximately 25° C. prior to their use in the analysis. The more hydrophilic liquid is dispensed from a 1 mL syringe using an automatic syringe pump at a rate of 13 to 15 μL/sec, until the drop has a total volume of between 5 to 6 The drop is allowed to hang in the bulk liquid, and video images are taken of the pendant drop during its growth and hang for a period of at least 10 sec, at a frame rate of 50 frames/sec. At least two replicate drops are measured with the image analysis software and the resulting replicate IFT values are averaged at each time point. The average data points obtained are plotted on a graph wherein IFT values (mN/m) and Drop Volume values (μL) are plotted on the two vertical y-axes, while time (sec) is plotted on the horizontal x-axis. Within the drop volume data series, the time point at which the growth in drop volume slows (just prior to stopping) is determined. This slowing-of-growth time point is defined as the “time zero” time point for Surface Age of the drop. All IFT values and drop volume values that were captured prior to this surface age time zero are discarded, and the plots' vertical y-axes are rescaled for the remaining data point ranges. The horizontal x-axis and its associated data values are transformed to represent the surface age values, commencing with the first remaining data point (which possesses a drop surface age of zero seconds). For IFT data points, the Surface Age values are deemed to be directly equivalent to the Bubble Lifetime values of Surface Tension (ST) data points from the Surface Tension method contained herein.

A curve is fitted to the remaining data points of IFT (mN/m) plotted versus surface age (sec), and subsequently the slope of the fitted curve at any given time point is determined, The procedures for fitting a curve to the measured surface tension values, and the subsequent determination of the slope of the curve at any given time point are both procedures that are conducted in accordance with the teachings of Hua, X., Rosen, M. J. Dynamic Surface Tension of Aqueous Surfactant Solutions 1: Basic Parameters, J. Colloid Interface Sci. 124, 2 (1988), as described in the following two equations. The curve equation to be fitted is:

$$InterfacialTension ( T ) = \frac{( {γ}_{0} - {γ}_{e} )}{( 1 + {( T / t )}^{n} )} + {γ}_{e}$$

wherein:
Interfacial Tension is the measured value of IFT when the fitted parameter values are unknown, and is the predicted value of IFT on the fitted curve when the parameter values have been determined and substituted into the equation,
T is the time elapsed (sec), at a given time point (i.e., bubble lifetime or drop surface age),
γ₀ is a fitted parameter value (mN/m), whose value is constrained to values>the value of the highest measured value of IFT,
γₑ is a fitted parameter value (mN/m), whose value is constrained to values<the value of γ₀ and greater than 0,
t is a fitted parameter value (sec), whose value is constrained to values>0,
n is a fitted parameter value (mN/m), whose value is constrained to values greater than 0 and equal or less than 2.

The constant values for the four fitted parameters in the curve equation are determined via the reiterative non-linear process of least sum of squares (of the residual errors). This modeling process is conducted by fitting to find constant values for the fitted curve equation parameters which yield the lowest Sum of Squares. This approach aims to minimize the difference between the input values (i.e. the measured IFT values) and the output values (i.e., the predicted IFT values). This curve fitting process is conducted using the “Solver” module within the spreadsheet software Microsoft Excel (such as version #14.0, 32-bit, available from Microsoft Corp. Redmond, Wash., U.S.A.). Within the Solver module of the Excel program, the following options are selected: Solver Method is set as GRG Nonlinear; and Convergence is set at 0.0001. The numerical constraints for each of the four parameters (as specified respectively alongside the equation) are imposed within the Excel program, in order to restrict the range of acceptable values for the parameter constants being determined. Additionally, the reiterative fitting process is seeded with starting values for each of the four parameter values being determines. These starting seed values are selected as follows: γ₀ is set as 110% of the highest measured IFT value; γₑ is set as equal to the IFT value measured at the longest time point; t is set as 1; and n is set as 1,

Once the least sum of squares process has determined constant values for the four fitted parameters in the curve equation, those fitted parameter values are substituted into the curve equation so that the equation can then be used to produce predicted values of IFT for any time point of interest. Using the equation of the fitted curve, predicted IFT values may be extrapolated to time points for which measured surface tension data were not collected.

Whether a predicted IFT value on the fitted curve is a dynamic value or a steady state value is determined as follows. The point on the fitted IFT curve at the time point of interest is identified. Next, the slope of the line at that time point is determined using the slope equation below (first derivative of the previous curve equation).

$$\frac{d ( InterfacialTension ( T ) )}{d T} = \frac{- ( {γ}_{0} - {γ}_{e} ) n ( \frac{1}{t} ) {( T / t )}^{n - 1}}{{( 1 + {( T / t )}^{n} )}^{2}}$$

wherein:
Interfacial Tension is the predicted value of IFT (mN/m), on the fitted curve,
T is the time elapsed (sec), at a given time point (i.e., bubble lifetime or drop surface age),
γ₀ is the fitted parameter value (mN/m), determined in the curve fitting procedure,
γₑ is the fitted parameter value (mN/m), determined in the curve fitting procedure,
t is the fitted parameter value (sec), determined in the curve fitting procedure,
n is the fitted parameter value (mN/m), determined in the curve fitting procedure.

The fitted curve may be extrapolated to extend beyond the range of measured values contained within the plotted data set. The value of the slope of the fitted curve at any given surface age time point indicates whether the predicted IFT value at that time point on the fitted curve is considered to be a Dynamic value or a Steady State value. At a given surface age time point, the predicted IFT value of the fitted curve is defined as being a Dynamic Interfacial Tension (DIFT) value if the absolute value (i.e. with the sign omitted) of the slope of the curve at that time point is greater than 0.05 mN/m·s. DIFT values at any time point along the fitted curve are reported in units of mN/m, at their respective surface age time point.

Predicted IFT values are also generated from the fitted curve equation from at least 25 time points (i.e., bubble lifetime or drop surface age), namely, the time points within the range of 0 sec to 10.8 sec, at intervals of 0.02 sec, and these values are used as specified for calculations within the Spreading Coefficient Test Method.

b. Surface Tension (SFT)/Dynamic Surface Tension (DSFT) Test Method

The surface tension of a given test liquid, such as the core liquid material or the shell liquid material, is measured using the bubble tensiometer instrument model SITA science line t60, and accompanying software SITA-Lab Solution v.1.4.1 (both available from SITA Messetechnik GmbH, Dresden, Germany), or equivalent. This instrument measures the surface tension of a liquid according to the bubble pressure approach, which involves injecting air into the test liquid via a capillary that is immersed within the test liquid, thereby forming a bubble within the test liquid. For the purposes of this invention, the term “dynamic” is not to be inherently associated with the measured SFT values reported by the tensiometer or accompanying software, regardless of how that terminology is used by the software or in common language. Rather, for SFT values the term “dynamic” is only to be associated with predicted SFT values that are output from the curve fitting and modelling procedures specified here, and which additionally meet the slope value criteria also specified herein.

The tensiometer is used to obtain surface tension measurements for the test liquid at multiple bubble lifetime time points, using the Auto function within the software. Between each sample tested the instrument is cleaned by rinsing the capillary tube and temperature probe with DI water, followed by their immersion in 20 mL of ethanol for 15 min, followed by their immersion in 20 mL of DI water. Instrument calibration is subsequently conducted with 20 mL of deionized (DI) water within the temperature range of 20-30° C. The instrument parameter values used during analysis are as follows. Mode is set as Auto-Measurement Mode; Start Bubble is set at 15 ms; End bubble is set at 50 s; Tolerance is set at 8%; Resolution is set at Medium; Average is set as 1; Skip is set as 0; Bar min (graph display) is set at 20; Bar max (graph display) is set at 80. The resolution selected is set to have 25 measurement points within the range of bubble lifetimes described in the parameters. The auto-measurement of the surface tension is conducted by placing the tip of the capillary tube and the temperature probe of the tensiometer into about 20 mL of the test liquid held in a glass vial. The temperature of the test liquid is held steady and within the range of 20-30° C. Three replicates samples are analyzed, and the average result is reported as the Surface Tension of the test material, expressed in units of mN/m, for each measurement time point within the range of 0.03-50 sec of bubble lifetimes. For SFT data points, the Bubble Lifetime values are deemed to be directly equivalent to the drop Surface Age values of Interfacial Tension data points from the IFT method contained herein.

A curve is fitted to the data points of SFT (mN/m) plotted versus surface age (sec), and subsequently the slope of the fitted curve at any given time point is determined,

The procedures for fitting a curve to the measured surface tension values, and the subsequent determination of the slope of the curve at any given time point are both procedures that are conducted in accordance with the teachings of Hua, X., Rosen, M. J. Dynamic Surface Tension of Aqueous Surfactant Solutions 1: Basic Parameters, J. Colloid Interface Sci. 124, 2 (1988), as described in the following two equations. The curve equation to be fitted is:

$$SurfaceTension ( T ) = \frac{( {γ}_{0} - {γ}_{e} )}{( 1 + {( T / t )}^{n} )} + {γ}_{e}$$

wherein:
Surface Tension is the measured value of SFT when the fitted parameter values are unknown, and is the predicted value of SFT on the fitted curve when the parameter values have been determined and substituted into the equation,
T is the time elapsed (sec), at a given time point (i.e., bubble lifetime or drop surface age),
γ₀ is a fitted parameter value (mN/m), whose value is constrained to values>the value of the highest measured value of SFT,
γₑ is a fitted parameter value (mN/m), whose value is constrained to values<the value of γ₀ and greater than 0,
t is a fitted parameter value (sec), whose value is constrained to values>0,
n is a fitted parameter value (mN/m), whose value is constrained to values greater than 0 and equal or less than 2.

The constant values for the four fitted parameters in the curve equation are determined via the reiterative non-linear process of least sum of squares (of the residual errors). This modeling process is conducted by fitting to find constant values for the fitted curve equation parameters which yield the lowest Sum of Squares. This approach aims to minimize the difference between the input values (i.e. the measured SFT values) and the output values (i.e., the predicted SFT values). This curve fitting process is conducted using the “Solver” module within the spreadsheet software Microsoft Excel (such as version #14.0, 32-bit, available from Microsoft Corp. Redmond, Wash., U.S.A.). Within the Solver module of the Excel program, the following options are selected: Solver Method is set as GRG Nonlinear; and Convergence is set at 0.0001. The numerical constraints for each of the four parameters (as specified respectively alongside the equation) are imposed within the Excel program, in order to restrict the range of acceptable values for the parameter constants being determined. Additionally, the reiterative fitting process is seeded with starting values for each of the four parameter values being determines. These starting seed values are selected as follows: γ₀ is set as 110% of the highest measured SFT value; γₑ is set as equal to the SFT value measured at the longest time point; t is set as 1; and n is set as 1,

Once the least sum of squares process has determined constant values for the four fitted parameters in the curve equation, those fitted parameter values are substituted into the curve equation so that the equation can then be used to produce predicted values of SFT for any time point of interest. Using the equation of the fitted curve, predicted SFT values may be extrapolated to time points for which measured surface tension data were not collected.

Whether a predicted SFT value on the fitted curve is a dynamic value or a steady state value is determined as follows. The point on the fitted SFT curve at the time point of interest is identified. Next, the slope of the line at that time point is determined using the slope equation below (first derivative of the previous curve equation).

$$\frac{d ( SurfaceTension ( T ) )}{d T} = \frac{- ( {γ}_{0} - {γ}_{e} ) n ( \frac{1}{t} ) {( T / t )}^{n - 1}}{{( 1 + {( T / t )}^{n} )}^{2}}$$

wherein:
Surface Tension is the predicted value of SFT (mN/m), on the fitted curve,
T is the time elapsed (sec), at a given time point (i.e., bubble lifetime or drop surface age),
γ₀ is the fitted parameter value (mN/m), determined in the curve fitting procedure,
γₑ is the fitted parameter value (mN/m), determined in the curve fitting procedure,
t is the fitted parameter value (sec), determined in the curve fitting procedure,
n is the fitted parameter value (mN/m), determined in the curve fitting procedure.

The value of the slope of the fitted curve at any given bubble lifetime time point indicates whether the predicted SFT value at that time point on the fitted curve is considered to be a Dynamic value or a Steady State value. At a given bubble lifetime time point, the predicted SFT value of the fitted curve is defined as being a Dynamic Surface Tension (DSFT) value if the absolute value (i.e. with the sign omitted) of the slope of the curve at that time point is greater than 0.05 mN/m·s. DSFT values at time points along the fitted curve are reported in units of mN/m, at their respective bubble lifetime time point.

Predicted SFT values are also generated from the fitted curve equation from at least 25 time points (i.e., bubble lifetime or drop surface age), namely, the time points within the range of 0 sec to 10.8 sec, at intervals of 0.02 sec, and these values are used as specified for calculations within the Spreading Coefficient Test Method.

c. Spreading Coefficient (SC)/Dynamic Spreading Coefficient (DSC) Test Method

Spreading Coefficient (SC) values for a particular combination of core liquid and shell liquid are determined as follows. First, Surface Tension (SFT) values are collected for the core liquid and the shell liquid according to the Surface Tension Test Method set forth herein. Next, Interfacial Tension (IFT) values are collected for the core liquid and the shell liquid combination according to the Interfacial Tension Test Method set forth herein. The Bubble Lifetime values of Surface Tension data points are deemed to be directly equivalent to the drop Surface Age values of Interfacial Tension data points from the IFT method contained herein. Spreading Coefficient (SC) values are next generated as follows. The initial calculated spreading coefficient values are calculated according to the initial spreading coefficient equation below at each of at least 25 time points (i.e., bubble lifetime or drop surface age) using the predicted values of IFT and SFT which are generated by the respective curve equations fitted via the least sum of squares modeling procedures specified in the respective test methods. The time points at which predicted values for IFT and SFT, and the initial spreading coefficient values are calculated are the time points within the range of 0 sec to 10.8 sec, at intervals of 0.02 sec.

initial spreading coefficient (at a given time point T)=γ_{CORE}−γ_{SHELL}−γ_{INTERFACIAL}

wherein:
Initial Spreading Coefficient is the initial calculated value of SC (in mN/m),
γ_{CORE} is the predicted SFT value of the core liquid (in mN/m), at a given time T,
γ_{SHELL} is the predicted SFT value of the shell liquid (in mN/m), at a given time T,
γ_{INTERFACIAL} is the predicted IFT value between core and shell liquids (in mN/m), at a given time T.

In a process similar to the curve fitting procedures specified within the IFT and SC test methods, a curve is also fitted to these initial calculated spreading coefficient values, and subsequently the slope of the curve at any given time point is determined, with both procedures conducted in accordance with the teachings of Hua, X., Rosen, M. J. Dynamic Surface Tension of Aqueous Surfactant Solutions 1: Basic Parameters, J. Colloid Interface Sci. 124, 2 (1988), as described in the following two equations. The curve equation to be fitted is:

$$SpreadingCoefficient ( T ) = \frac{( {γ}_{0} - {γ}_{e} )}{( 1 + {( T / t )}^{n} )} + {γ}_{e}$$

wherein:
Spreading Coefficient is the initial calculated value of SC when the fitted parameter values are unknown, and is the predicted value of SC on the fitted curve when the parameter values have been determined and substituted into the equation,
T is the time elapsed (sec), at a given time point (i.e., bubble lifetime or drop surface age),
γ₀ is a fitted parameter value (mN/m), whose value is constrained to values>the value of the highest initial calculated value of SC,
γₑ is a fitted parameter value (mN/m), whose value is constrained to values<the value of γ₀
t is a fitted parameter value (sec), whose value is constrained to values>0,
n is a fitted parameter value (mN/m), whose value is constrained to values greater than 0 and equal or less than 2.

The constant values for the four fitted parameters in the curve equation are determined via the reiterative non-linear process of least sum of squares (of the residual errors). This modeling process is conducted by fitting to find constant values for the fitted curve equation parameters which yield the lowest Sum of Squares. This approach aims to minimize the difference between the input values (i.e. the initial calculated spreading coefficients) and the output values (i.e., the predicted SC values). This curve fitting process is conducted using the “Solver” module within the spreadsheet software Microsoft Excel (such as version #14.0, 32-bit, available from Microsoft Corp. Redmond, Wash., U.S.A.). Within the Solver module of the Excel program, the following options are selected: Solver Method is set as GRG Nonlinear; and Convergence is set at 0.0001. The numerical constraints for each of the four parameters (as specified respectively alongside the equation) are imposed within the Excel program, in order to restrict the range of acceptable values for the parameter constants being determined. Additionally, the reiterative fitting process is seeded with starting values for each of the four parameter values being determines. These starting seed values are selected as follows: γ₀ is set as 110% of the highest initial calculated SC value; γₑ is set as equal to the initial calculated SC value at the longest time point calculated (i.e. 10.8 sec); t is set as 1; and n is set as 1,

Once the least sum of squares process has determined constant values for the four fitted parameters in the curve equation, those fitted parameter values are substituted into the curve equation so that the equation can then be used to produce predicted values of SC for any time point of interest. Using the equation of the fitted curve, predicted spreading coefficient values may be extrapolated for time points of bubble lifetime or drop surface age for which measured surface tension and measured interfacial tension data were not collected.

Whether a predicted Spreading Coefficient value on the fitted curve is a dynamic value or a steady state value is determined as follows. The point on the fitted spreading coefficient curve at the time point of interest is identified. Next, the slope of the line at that time point is determined using the slope equation below (first derivative of the previous curve equation).

$$\frac{d ( SpreadingCoefficient ( T ) )}{d T} = \frac{- ( {γ}_{0} - {γ}_{e} ) n ( \frac{1}{t} ) {( T / t )}^{n - 1}}{{( 1 + {( T / t )}^{n} )}^{2}}$$

wherein:
Spreading Coefficient is the predicted value of SC (mN/m), on the fitted curve,
T is the time elapsed (sec), at a given time point (i.e., bubble lifetime or drop surface age),
γ₀ is the fitted parameter value (mN/m), determined in the curve fitting procedure,
γₑ is the fitted parameter value (mN/m), determined in the curve fitting procedure,
t is the fitted parameter value (sec), determined in the curve fitting procedure,
n is the fitted parameter value (mN/m), determined in the curve fitting procedure.

If the slope of the curve of predicted spreading coefficient values, at a selected time point of interest, is greater than 0.05 mN/m·s, then the predicted spreading coefficient value at that time point on the curve is defined as being a Dynamic Spreading Coefficient (DSC) value. If the slope of the spreading coefficient curve at a selected time point of interest is less than or equal to 0.05 mN/m·s, then the predicted spreading coefficient value at that time point on the curve is defined as being a Steady State Spreading Coefficient value.

d. Mean Equivalent Diameter (D) Test Method

A population of microcapsules is characterized by their Mean Equivalent Diameter (D) value, which is obtained using the computerized image analysis software ImageJ version 1.46r, (available from the National Institutes of Health, Bethesda, Md., USA, http://imagej.nih.gov/ij/, 1997-2012), to analyze images of microcapsules obtained via microscopy. The type of microscope instrument, along with the illumination source and geometry, detector type and geometry, and any instrument or software options affecting image contrast, are all carefully selected and set up such that the combined configuration of the instrument yields images of the microcapsules that display an evenly illuminated background and are substantially free from side-directional shadowing and highlighting, or other illumination effects which hinder accurate rendering of the object perimeter when processed through the ImageJ automatic thresholding function. One such suitable microscope is the Scanning Electron Microscope (SEM) model Hitachi TM-1000 Table Top SEM (available from Hitachi High-Technologies Europe GmbH, Germany).

A sample of about 30 mg of the microcapsule powder test material is prepared for examination under the microscope, by dispersing the sample of microcapsules as a uniform monolayer having minimal agglomerations of particles. In using SEM, the sample may be adhered to a stub (such as a 12.5 mm diameter Aluminum Pin Stub G301, mounted with 12 mm diameter Leit Adhesive Carbon tab, as available from Agar Scientific, Essex, UK). The microscope is operated at a magnification of approximately 100× and is used to obtain images of at least 500 randomly selected microcapsules per sample preparation, via capturing at least ten images per sample of the test material. From the ten or more images captured, at least three images are selected for image analysis, while ensuring that sufficient images are selected to depict a monolayer of at least 300 microcapsules in total. Each of the images to be analyzed is calibrated for linear scale and the scale used is in micrometers (μm). Each image is captured as, or converted to, 8-bit grayscale pixel depth, and then automatically thresholded to create a binary (black and white) image. The grey level value to be used as the threshold value is obtained by applying the ImageJ software's automatic threshold function independently to each grey scale image. This automatic thresholding function yields a binary image wherein pixels representing the microcapsules become the foreground objects and regions-of-interest, and which are separated from the background pixels. The area (in square micrometers) of each region-of-interest object representing an individual microcapsule is then measured with the ImageJ software by selecting “Area” on the “Set Measurement” menu, and within “Area” selecting “Exclude Edge Particles” and “circularity”. Then for “circularity” entering the range of values from about 0.4 to about 1 on the “Analyze Particles” menu.

The obtained areas (A, in sq. μm) are recorded and used to calculate the equivalent diameters of perfect circles, according to following formula:

dᵢ=√(4Aᵢ/π)

wherein:
dᵢ is the equivalent diameter in micrometers, and
Aᵢ is the area obtained from ImageJ for a given microcapsule.

Then, equivalent diameters (dᵢ) are rank-ordered from largest to smallest size and the mean microcapsule equivalent diameter is obtained and reported using following formula:

$$D = \frac{{\sum }_{i = 1}^{n} {d}_{i}}{n}$$

wherein:
D is the mean microcapsule equivalent diameter in micrometers,
dᵢ are the individual equivalent diameters of the microcapsules as calculated above in micrometers, and
n is the total number of microcapsules analyzed, using a minimum of 300 microcapsules to obtain such mean.

Additionally, the 5^{th}, 50^{th} and 95^{th} percentile values are also calculated and reported for these equivalent diameter data points.

e. Coefficient of Variation (CoV) of the Equivalent Diameters Test Method

A population of microcapsules (or encapsulated benefit agent particles) is characterized by a coefficient of variation (CoV) of the equivalent diameters, corresponding to the ratio between the distribution of equivalent diameters in said population of microcapsules (i.e., the standard deviation) and the mean microcapsule equivalent diameter. CoV is obtained as follows. First, the Standard Deviation (STD) of the mean microcapsules' equivalent diameter is obtained using following formula:

$$STD = \sqrt{\frac{{\sum }_{i = 1}^{n} {( {d}_{i} - \overline{D} )}^{2}}{n}}$$

wherein:
STD is the standard deviation of the equivalent diameters in micrometers.
D is the mean equivalent diameter in micrometers of the microcapsules,
dᵢ are the individual equivalent diameters in micrometers of the microcapsules as calculated above, and
n is the total number of microcapsules analyzed, using a minimum of 300 microcapsules to obtain such STD.

Finally, the coefficient of variation (CoV) of the equivalent diameters of a population of microcapsules is obtained using following formula:

$$CoV = \frac{STD \times 100}{D}$$

wherein:
CoV is the coefficient of variation of the equivalent diameters of a population of microcapsules in %.
STD and D are the standard deviation and the mean equivalent diameter in micrometers, respectively, as calculated above.

f. Dynamic Vapor Sorption (DVS) Water Sorption Test Method

Dynamic Vapor Sorption (DVS) water sorption is a gravimetric technique that measures the mass of a sample as it changes in response to changes in humidity. The Dynamic Vapor Sorption water sorption percentage of a test material (e.g. polymer) when exposed to humidity is measured by using a ProUmid SPS-DVS Instrument (available from ProUmid GmbH & Co. KG, Ulm, Germany), or equivalent. The instrument is capable of resolving changes in sample weight as small as 0.1 μg. The accuracy of the system conditions is ±0.5% for the relative humidity (RH), and ±0.3° C. for temperature. A 100 to 200 mg sample of the test material is placed onto the specimen chamber microbalance of the DVS instrument and the instrumental temperature is fixed at 30° C. The test material sample is held at 30° C. and 30% RH until the mass was stable over time (i.e. a change in mass per unit time that is lower than 0.02 mg/h). The precise initial weight of the equilibrated sample is determined and recorded. The relative humidity that the sample is exposed to within the instrument is then raised in a single step from 30% to 80% RH (sorption). The sample weight is monitored until the change in mass per unit of time is less than 0.02 mg/h, at which time the stabilized final weight is determined and recorded. For each sample, the DVS water sorption percentage value is the difference between the initial sample weight and the final sample weight, calculated as a percentage of the initial weight. For each test material, three replicate samples are measured using a new fresh sample for each replicate. The DVS water sorption percentage value reported for the test material is the average of the DVS water sorption percentage values obtained from the three replicate samples.

g. Viscosity Test Method

Viscosity measurements of a test material are obtained using a model ARG2 stress-controlled rheometer having a 40 mm 1° cone and plate geometry (available from TA Instruments, Inc. (New Castle, Del., U.S.A.). This geometry has an inherent nominal cone truncation distance of 26 μm. All measurements are performed after 3 minutes of equilibration at 20° C. under a constant shear rate of 0.01 l/s, preceded by a pre-shear stage of 10 seconds at a shear rate of 10 l/s. Shear viscosity versus shear rate profiles are acquired in continuous ramp mode from 0.01 to 1,200 l/s taking at least 30 points per shear rate decade in logarithmic distribution. The viscosity value for each analysis is calculated as the average of the shear viscosity values measured during the shear rates ranging from 10 to 1000 s⁻¹. For each test material, the analysis is conducted in triplicate using a new fresh sample for each replicate. The viscosity value reported for the test material is the average viscosity value calculated from the triplicate analyses, reported in units of cP (centipoise).

h. Core Liquid Loading Test Method

Thermogravimetric analysis (TGA) is conducted using a TGA analyzer such as the model Q-5000 available from TA Instruments, Inc. (New Castle, Del., U.S.A.) or equivalent, to determine the average Core Liquid Loading for a population of microcapsules in powder form. The Q-5000 has a weighing precision of 0.01%; a sensitivity of 0.1 μg; an isothermal temperature accuracy of 1° C.; and isothermal temperature precision of 0.1° C. TGA is used to measure the weight change of a population of microcapsules as a function of temperature and time, under a controlled atmosphere. A gas purge system removes the decomposition materials during testing.

The sample of microcapsules is heated to a temperature which is both higher than the boiling point of the core material and is also lower than the degradation temperature of the shell material, such that the core material is vaporized and released while the mass of the shell material is principally left behind. One of skill will of course recognize however that such a temperature may not exist for all combinations of core and shell materials. For the purposes of this test method the temperature of 250° C. is specified. This value has been shown to be broadly suitable for many relevant combinations of core and shell materials.

The microcapsules to be sampled for testing is preconditioned by equilibrating it to the laboratory's ambient atmospheric conditions (approximately 25° C. and 50% RH) prior to being weighed. Open platinum pans are used to hold the test sample during analysis, and the precisely known sample weight is within the range of 15 to 20 mg of microcapsule powder. All analyses are conducted with the test sample under a nitrogen atmosphere with a flow rate of 25 mL/min. The TGA instrument is configured to run the following temperature profile conditions for the initial analysis: Initial Ramp at 20° C./minute to 250° C., followed by an Isothermal Hold at 250° C. for 30 minutes. The percent weight loss value reported is the value measured at the time point when the derivative “% loss/minute” drops below 0.05%/min. Measurements are collected from two replicate samples, using a new fresh sample for each replicate. The results from the replicate samples are averaged. The average measured result is reported as the Core Liquid Loading (as % by weight of the microcapsules).

### V. EXAMPLES

The following examples are given solely for the purpose of illustration and are not to be construed as limitations of the invention as many variations are possible without departing from the spirit and the scope of the invention.

### Example #1

A shell liquid and core liquid were prepared as follows. The core liquid comprised a 50:50 by weight mixture of L-menthol (available from Symrise AG) and menthyl lactate (also available from Symrise AG), which are initially solids but form an oil when mixed and melted. This mixture remains a liquid when cooled to room temperature. The core liquid was prepared by mixing both solids and then heating them to approximately 50° C. until a transparent oil formed. Once the mixture was a liquid, 1% by weight of sodium dioctyl sulfosuccinate (available from Cytec Industries, Inc. under the name AEROSOL™ OT) was added to the liquid.

The shell liquid was prepared by mixing 10 wt % of Eastman AQ™38 S (available from Eastman Chemical Company), 0.5 wt % of SDS (available from Sigma-Aldrich GmbH) and 0.5 wt % of DYNOL™ 960 (available from Air Products and Chemicals, Inc.) in water.

The shell liquid and the core liquid were each loaded into a separate syringe pump, such as, for example a programmable syringe pump model PHD 4400 available from Harvard Apparatus (USA). The syringe pumps were connected to a concentric flow microfluidic device, such as, for example, Flow Focusing® device model # PSC0350F available from Ingeniatrics SA. This microfluidic device has fundamentally the same configuration as that shown in FIG. 3. The microfluidic nozzle was disposed at an opening in a top wall of co-current spray dryer that was operated at ambient temperature (i.e., the air supplied to the spray dryer was not heated). The spray dryer was a GEA Niro Mobile Minors unit and is configured so that a gas enters the spray dryer in swirling manner from an annulus surrounding the opening in the top wall of the spray dryer.

The shell liquid and the core liquid were pumped thru the microfluidic device using the syringe pumps. The flow rates of the shell liquid was adjusted to 15.4 ml/hr, and the flow rate of the core liquid was adjusted to 4.6 ml/hr. Ambient air was used as the pressurizing gas for the pressurizing chamber.

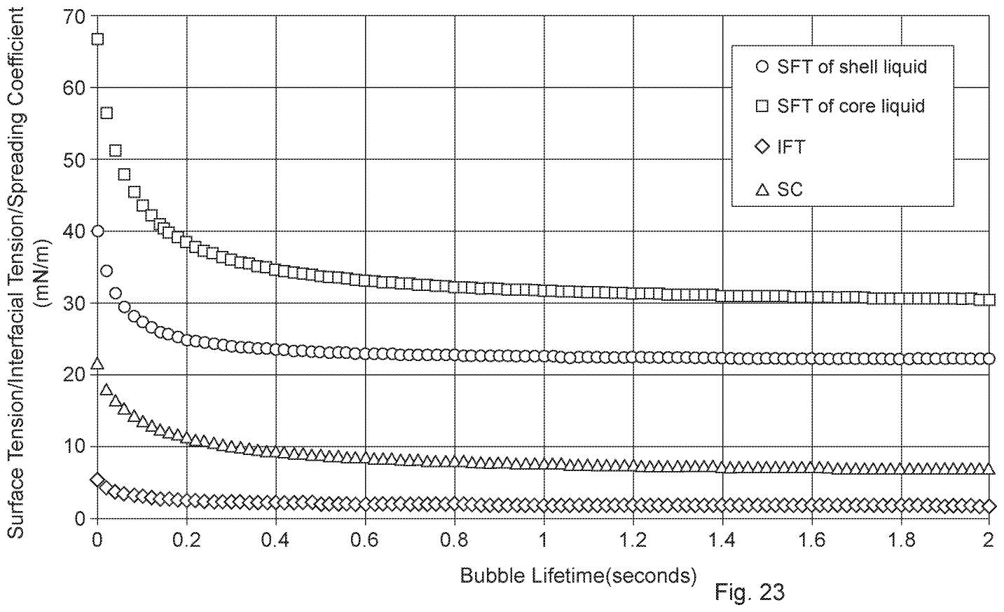

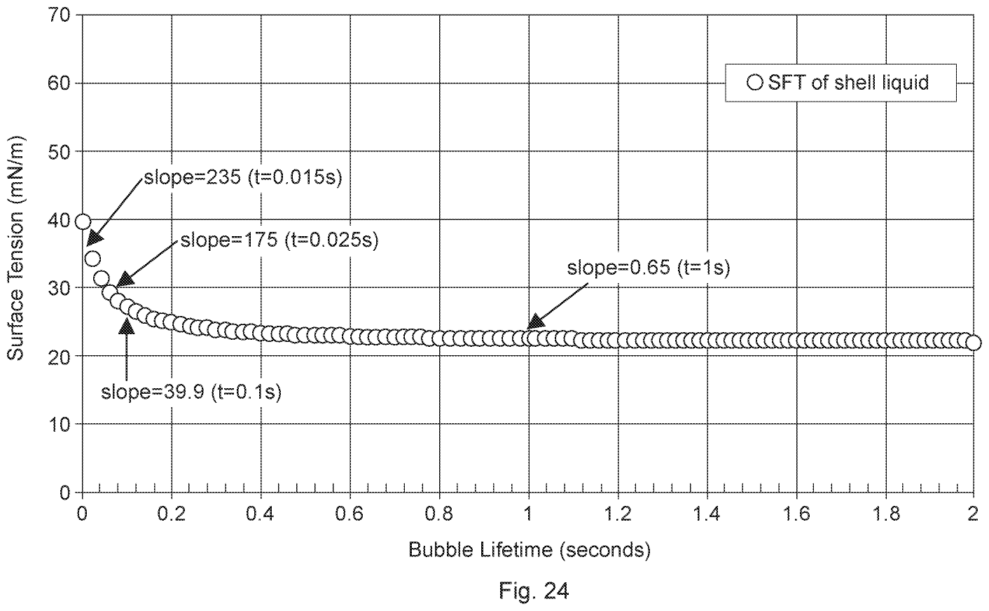

FIG. 23 is a graph of: (i) the surface tensions (SFTs) of the core liquid and the shell liquid of Example 1, (ii) the interfacial tension (IFT) between the core liquid and the shell liquid of Example 1, and (iii) the spreading coefficient (SC) of the shell liquid and the core liquid of Example 1. FIG. 24 is a graph of just the surface tension (SFT) of the shell liquid with the slopes (mN/m·s) of the line annotated at specific times T. At T=1 second, the slope of the line is 0.65 mN/m·s, therefore the surface tension at T=1 is considered dynamic at T=1. The surface tension line was fitted using equation (1) below while the slope of the surface tension line at a time T was calculated using equation (2) below.

$$\begin{matrix}SFT ( T ) or IFT ( T ) = \frac{( {γ}_{0} - {γ}_{e} )}{( 1 + {( T / t )}^{n} )} + {γ}_{e} & Equation ( 1 ) \\ \frac{d ( SFT ( T ) )}{dT} = \frac{- ( {γ}_{0} - {γ}_{e} ) n ( \frac{1}{t} ) {( T / t )}^{n - 1}}{{( 1 + {( T / t )}^{n} )}^{2}} & Equation ( 2 )\end{matrix}$$

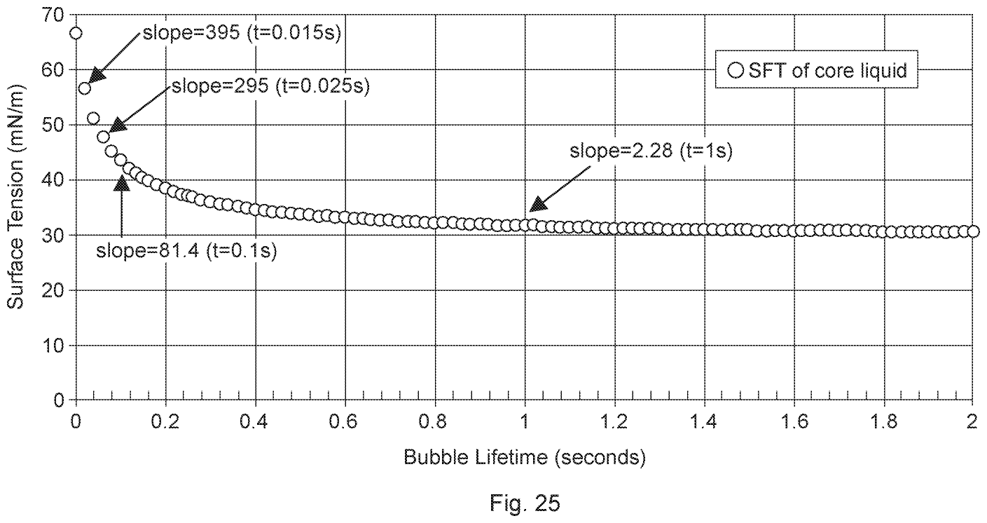

FIG. 25 is a graph of just the surface tension (SFT) of the core liquid with slopes (mN/m·s) of the line annotated at specific times T. At T=1 second, the slope of the line is 2.28 mN/m·s, therefore the surface tension at T=1 is considered dynamic. The surface tension line was fitted using equation (1) above while the slope of the surface tension line at a time T was calculated using equation (2).

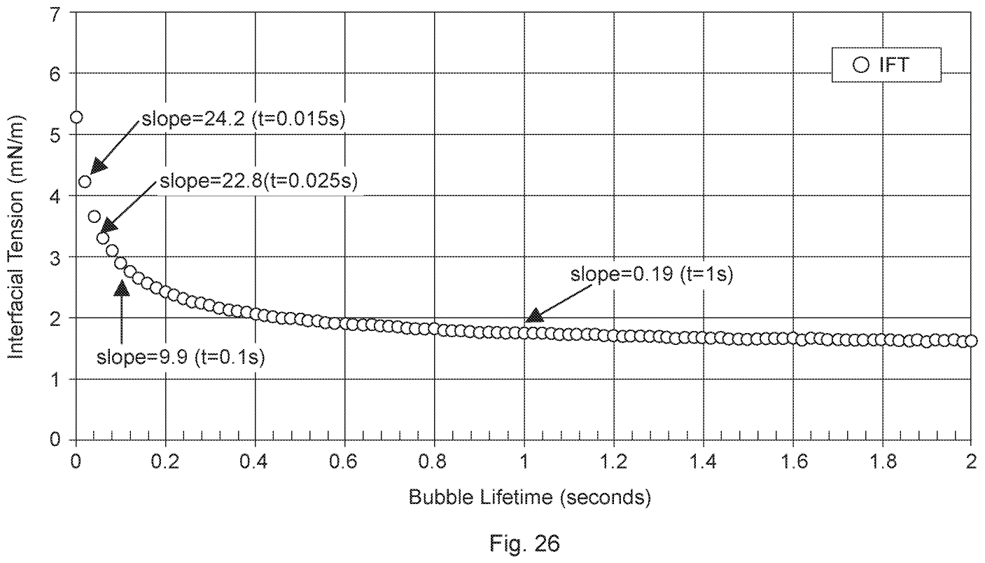

FIG. 26 is a graph of just the interfacial tension (IFT) between the core liquid and the shell liquid with slopes (mN/m·s) of the line annotated at specific times T. At T=1 second, the slope of the line is 0.19 mN/m·s, therefore the surface tension at T=1 is considered dynamic. The surface tension line was fitted using equation (1) above while the slope of the surface tension line at a time T was calculated using equation (2).

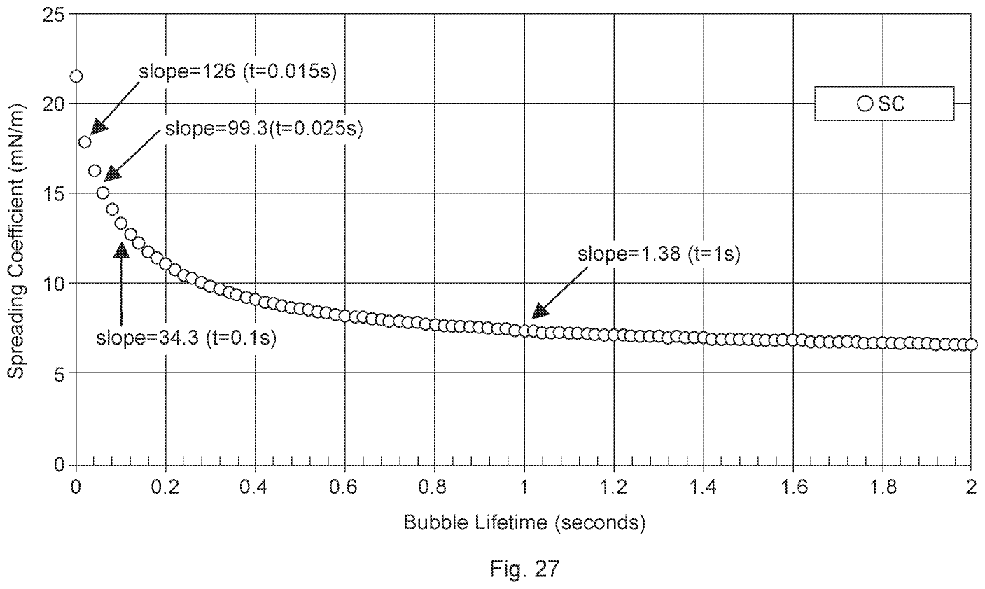

FIG. 27 is a graph of just the spreading coefficient (SC) of the core liquid and the shell liquid of Example 1 with slopes (mN/m·s) of the line annotated at specific times T. At T=1 second, the slope of the line is 1.38 mN/m·s, therefore the spreading coefficient at T=1 is considered dynamic. The surface tension line was fitted using equation (1) above while the slope of the surface tension line at a time T was calculated using equation (2).

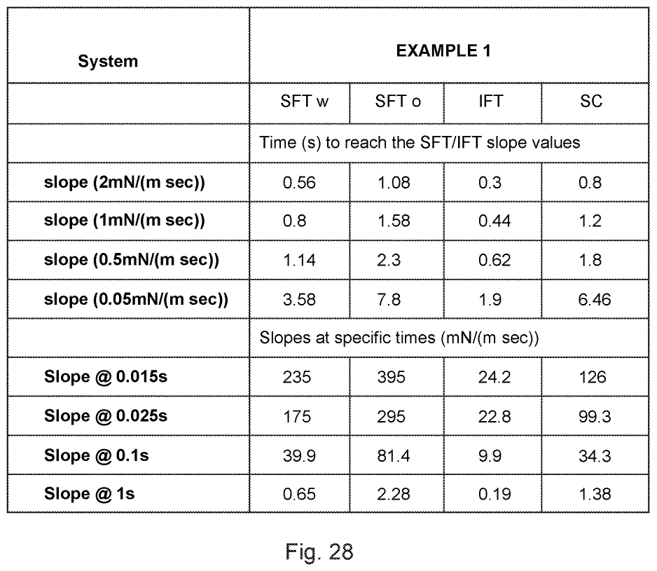

FIG. 28 is a table summarizing, in the top half, the time required to reach steady state values (i.e., values less than or equal to 0.05 mN/m·s) for surface tension (SFT) of the shell liquid, surface tension (SFT) of the core liquid, interfacial tension (IFT) and the spreading coefficient (SC). The table summarizes in the bottom half the various annotated values in the graphs of FIGS. 23, 24, 25, 26 and 27.

A population of microcapsules was collected at the exit of the spray dryer. Thermogravimetric analysis indicated an average core liquid loading of approximately 28 wt %.

### Comparative Example #2

A shell liquid and core liquid were prepared as follows. The core liquid comprised a 50:50 by weight mixture of L-menthol (available from Symrise AG) and menthyl lactate (also available from Symrise AG), which are initially solids but form an oil when mixed and melted. This mixture then remains an oil when cooled to room temperature. The core liquid mixture was prepared by mixing both solids and then heating them to approximately 50° C. until a transparent oil formed. The shell liquid was prepared by mixing 10 wt % of Eastman AQ™38 S (available from Eastman Chemical Company) in water.

The shell liquid and the core liquid were each loaded into a separate syringe pump, such as, for example a programmable syringe pump model PHD 4400 available from Harvard Apparatus (USA). The syringe pumps were connected to a concentric flow microfluidic device, such as, for example, Flow Focusing® device model # PSC0350F available from Ingeniatrics SA. This microfluidic device has fundamentally the same configuration as that shown in FIG. 3. The microfluidic nozzle was disposed at an opening in a top wall of a co-current spray dryer that was operated at ambient temperature (i.e., the air that was supplied to the spray dryer was not heated). The spray dryer was a GEA Niro Mobile Minors unit. This spray dyer is a concurrent spray dryer in which a gas enters the spray dryer in swirling manner from an annulus surrounding the opening.

The shell liquid and the core liquid were pumped thru the microfluidic device using the syringe pumps. The flow rate of the shell liquid was adjusted to 15.4 ml/hr, and the flow rate of the core liquid was adjusted to 4.6 ml/hr. Ambient air was used as the pressurizing gas for the pressurizing chamber.

The spreading coefficient for this core liquid and shell liquid is shown in FIG. 21. No microcapsules were collected at the exit of the spray dryer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for producing microcapsules, comprising:
providing a core liquid comprising one or more oils and one or more surfactants;
providing a shell liquid comprising water, one or more surfactants and at least one wall forming material;
forming a plurality of liquid droplets within a gas, wherein each of the plurality of liquid droplets comprise a core formed from the core liquid and a shell surrounding the core formed from the shell liquid, wherein the core liquid and shell liquid have a dynamic spreading coefficient greater than zero at 0.03 seconds; and
evaporating, within a drying chamber, at least some of the water from each of the plurality of liquid droplets to form a microcapsule there from.

2. A method according to claim 1, wherein the water has a concentration greater than 60% by weight of the shell liquid.

3. A method according to claim 1, wherein the wall forming material is selected from the group consisting of polyesters, shellacs and mixtures thereof.

4. A method according to claim 1, wherein the core liquid comprises greater than 80% by weight of the one or more oils.

5. A method according to claim 1, wherein the step of forming the plurality of liquid droplets further comprises using a microfluidic device to form a bi-component liquid stream comprising the core liquid and the shell liquid.

6. A method according to claim 5, wherein the microfluidic device comprises a first channel and a second channel, the first channel having the core liquid flowing there through and the second channel having the shell liquid flowing there through.

7. A method according to claim 1, wherein the wall forming material has a concentration greater 5% by weight of the shell liquid.

8. A method according to claim 1, wherein the one or more surfactants have a total concentration less than 3% by weight of the shell liquid.

9. A method according to claim 1, wherein the shell liquid has a dynamic surface tension less than 30 mN/m at T=0.1 seconds.

10. A method according to claim 1, wherein the core liquid and the shell liquid have a dynamic interfacial tension greater than zero and less than 3 mN/m at T=0.03 seconds.

11. A method according to claim 1, wherein the difference between a dynamic surface tension of the core liquid and a dynamic surface tension of the shell liquid is greater than 2 mN/m.

12. A method according to claim 11, wherein a dynamic surface tension of the core liquid and a dynamic surface tension of the shell liquid are between 20 mN/m and 70 mN/m.

13. A method according to claim 1, wherein the microcapsules have a core liquid loading greater than 20%.

14. A method according to claim 1, wherein the one or more surfactants of the shell liquid comprises a surfactant having a siloxane functional group.

15. A method according to claim 1, wherein the wall forming material is a polyester.

16. A method according to claim 15, wherein the polyester has a concentration between about 8% and about 12% by weight of the shell liquid.

17. A method according to claim 1, wherein the shell liquid comprises two or more surfactants.

18. A method according to claim 17, wherein the two more surfactants reduce the dynamic surface tension of the shell liquid by greater than 40% at T=0.1 seconds.

19. A method according to claim 17, wherein the two or more surfactants of the shell liquid are selected from the group consisting of anionic surfactants, sulfosuccinate surfactants, surfactants having a siloxane functional group and mixtures thereof.

20. A method according to claim 19, wherein the two or more surfactants of the shell liquid comprise sodium dodecyl sulfate and a surfactant having a siloxane functional group.
